(19) United States
(12) Patent Application Publication
(10) Pub. No.: US 2024/0167480 A1
(43) Pub. Date: May 23, 2024

(54) DUAL ENGINE PARALLEL PUMPING TRAILER SYSTEM

(71) Applicant: Revolution Equipment Rental Limited Liability Company, Longview, TX (US)

(72) Inventors: John Novotny, Montgomery, TX (US); Jeremy Benjamin Puck, Manning, IA (US)

(21) Appl. No.: 18/512,876

(22) Filed: Nov. 17, 2023

Related U.S. Application Data
(60) Provisional application No. 63/427,342, filed on Nov. 22, 2022.

(51) Int. Cl. F04D 13/14; F04D 17/16

(52) U.S. Cl. CPC F04D 13/14; F04D 17/168; F05D 2270/3013

(57) ABSTRACT

In one or more arrangements, a pumping system is presented having a plurality of pumps with inlets and outlets, wherein liquid enters the pumps through the inlets and exists the pumps through the outlets. In one or more arrangements, the pumping system has a plurality of engines configured to provide power to the plurality of pumps. In one or more arrangements, the pumping system has a plurality of tubes connected to the plurality of pumps such that liquid exiting the plurality of pumps flows through the plurality of tubes. In one or more arrangements, the plurality of tubes, and liquid flowing through the plurality of tubes, converge at an intersection. In one or more arrangements, the pumping system has a baffle positioned at the intersection to smooth the convergence of the liquid flowing through the plurality of tubes.

### CROSS REFERENCE TO RELATED APPLICATIONS

This application claims the benefit of U.S. Provisional Application No. 63/427,342 filed on Nov. 22, 2022, titled “DUAL ENGINE PARALLEL PUMPING TRAILER SYSTEM,” the entirety of which is hereby incorporated by reference herein in its entirety.

### FIELD OF THE DISCLOSURE

This disclosure relates to a pumping system. More specifically, this disclosure relates to a system for pumping water or other liquids at oil and gas extraction sites, particularly in connection with oil fracking operations.

### OVERVIEW OF THE DISCLOSURE

In many operations, particularly in many oil and gas extraction operations, liquid needs to be pumped from one location to another for various purposes. In many of these situations, liquid is pumped from a tank or reservoir which is man-made, and the man-made tank or reservoir is often filled by pumping liquid, such as water, into the tank or reservoir from a place where the liquid is naturally found, such as an ocean, lake, river, pond, or other body of water. In certain operations, there may be multiple holding tanks or reservoirs in different locations throughout one job site and liquid may need to be transferred from one tank or reservoir to another. Additionally, liquid may need to be transferred from any given tank or reservoir to a location for cooling, treatment, fire suppression, or many other purposes. In order to facilitate the movement of liquid to and throughout these job sites, pumping systems are required. Additionally, in many instances it may be desired that the pumping systems are capable of transportation in order to support pumping of liquid at various locations throughout a job site.

Particularly in oil and gas extraction operations, liquid needs to be pumped to various locations at oil and gas extraction sites in order to cooling and, sometimes, in order to suppress a fire. In these operations, liquid must be pumped quickly and a pumping system must be relatively quickly available at any location on an oil and gas extraction site. Recently the requirements for pumping liquids at oil and gas extraction sites doubled. That is, in certain situations, liquid was previously required to be pumped at 2,100 gallons per minute, which could often times be accomplished by using a 325-horsepower engine connected to a pump. However, as previously mentioned, certain requirements have increased and now liquid is required to be pumped at 4,200 gallons per minute. Many of these extraction sites have engines and pumps which were able to meet previous requirements, but now new engines and pumps are required unless there is some way to combine the previously used engines and pumps to meet the new requirements.

Therefore, for all the reasons stated above, and the reasons stated below, there is a need in the art for an improved pumping system. Thus, it is a primary objective of the disclosure to provide a dual engine parallel pumping trailer system that improves upon the state of the art.

Another objective of the disclosure is to provide a dual engine parallel pumping trailer system which meets pumping requirements.

Yet another objective of the disclosure is to provide a dual engine parallel pumping trailer system which utilizes engines and pumps already available and/or owned.

Another objective of the disclosure is to provide a dual engine parallel pumping trailer system which is safe to operate.

Yet another objective of the disclosure is to provide a dual engine parallel pumping trailer system which is easy to transport.

Another object of the disclosure is to provide a dual engine parallel pumping trailer system which is quick to transport.

Yet another objective of the disclosure is to provide a dual engine parallel pumping trailer system which is able to comply with road width travel restrictions.

Yet another objective of the disclosure is to provide a dual engine parallel pumping trailer system which is relatively easy to build.

Another objective of the disclosure is to provide a dual engine parallel pumping trailer system which is relatively friendly to build.

Yet another objective of the disclosure is to provide a dual engine parallel pumping trailer system which can be built relatively quickly and efficiently.

Another objective of the disclosure is to provide a dual engine parallel pumping trailer system which is easy to operate.

Yet another objective of the disclosure is to provide a dual engine parallel pumping trailer system which is relatively cost friendly to manufacture.

Yet another objective of the disclosure is to provide a dual engine parallel pumping trailer system which is aesthetically appealing.

Another objective of the disclosure is to provide a dual engine parallel pumping trailer system which is robust.

Yet another objective of the disclosure is to provide a dual engine parallel pumping trailer system which is water resistant.

Another objective of the disclosure is to provide a dual engine parallel pumping trailer system which is relatively inexpensive.

Yet another objective of the disclosure is to provide a dual engine parallel pumping trailer system which is not easily susceptible to wear and tear.

Another objective of the disclosure is to provide a dual engine parallel pumping trailer system which has a long useful life.

Yet another objective of the disclosure is to provide a dual engine parallel pumping trailer system which is efficient to use and operate.

These and other objects, features, or advantages of the disclosure will become apparent from the specification, figures, and claims.

### SUMMARY OF THE DISCLOSURE

In one or more arrangements, a dual engine parallel pumping trailer system is presented having a trailer, a first pump connected to a first engine and a first tube, and a second pump connected to a second engine and a second tube. In one arrangement, the first tube and the second tube converge at an intersection and a baffle is placed at the intersection. In one arrangement, the baffle is configured to smooth the convergence of the flow of liquid at the intersection. In one arrangement, pressure sensors are provided in order to measure inlet pressure and outlet pressure of liquid. In one arrangement, a flow meter is provided in order to measure the flow rate of liquid. In one arrangement, a master control system is provided to monitor the pressure and flow rate of liquid and confirm the pressure and flow rate are within desired minimum and maximum ranges.

### BRIEF DESCRIPTION OF THE FIGURES

FIG. 1 is a perspective view of a dual engine parallel pumping trailer system, in accordance with one or more arrangements; the view showing the system having a trailer, a liquid inlet system, a first pump connected to a first engine, a second pump connected to a second engine, a liquid outlet system, and a control system; the view showing a first conduit running from the liquid inlet system to the first pump, and a second conduit running from the liquid inlet system to the second pump; the view showing a first tube running from the first pump to the liquid outlet system and a second tube running from the second pump to the liquid outlet system; the view also showing the control system having a master control system, a first control system, and a second control system.

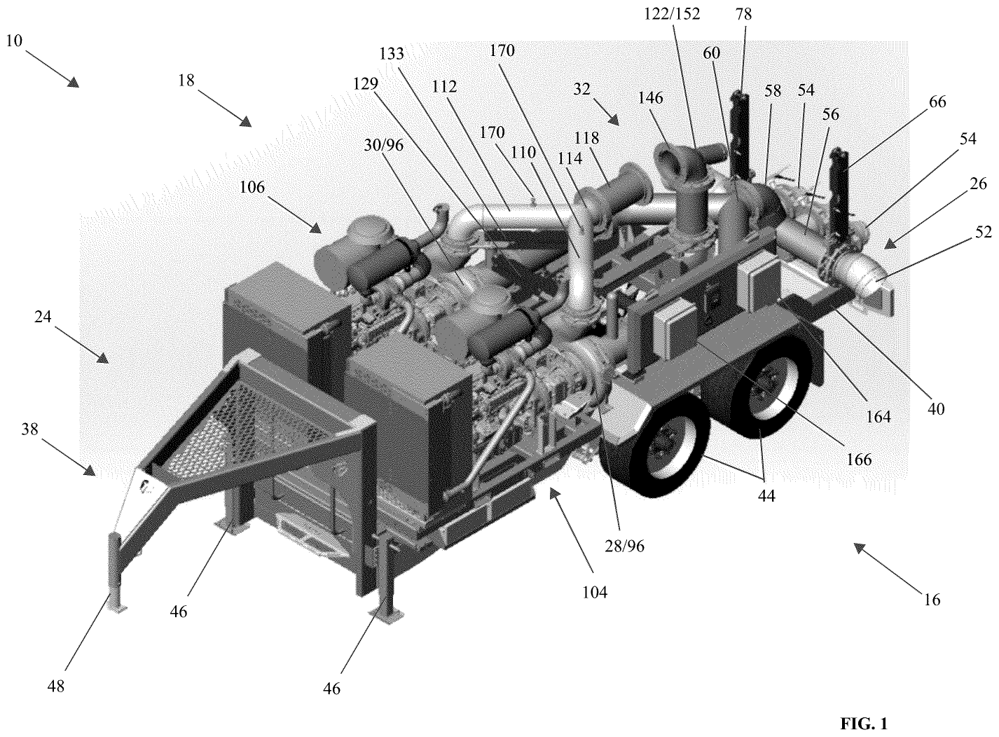

FIG. 2 is another perspective view of a dual engine parallel pumping trailer system, in accordance with one or more arrangements; the view showing the system having a trailer, a liquid inlet system, a first pump connected to a first engine, a second pump connected to a second engine, a liquid outlet system, and a control system; the view showing a first conduit running from the liquid inlet system to the first pump, and a second conduit running from the liquid inlet system to the second pump; the view showing a first tube running from the first pump to the liquid outlet system and a second tube running from the second pump to the liquid outlet system; the view also showing the control system having a master control system, a first control system, and a second control system.

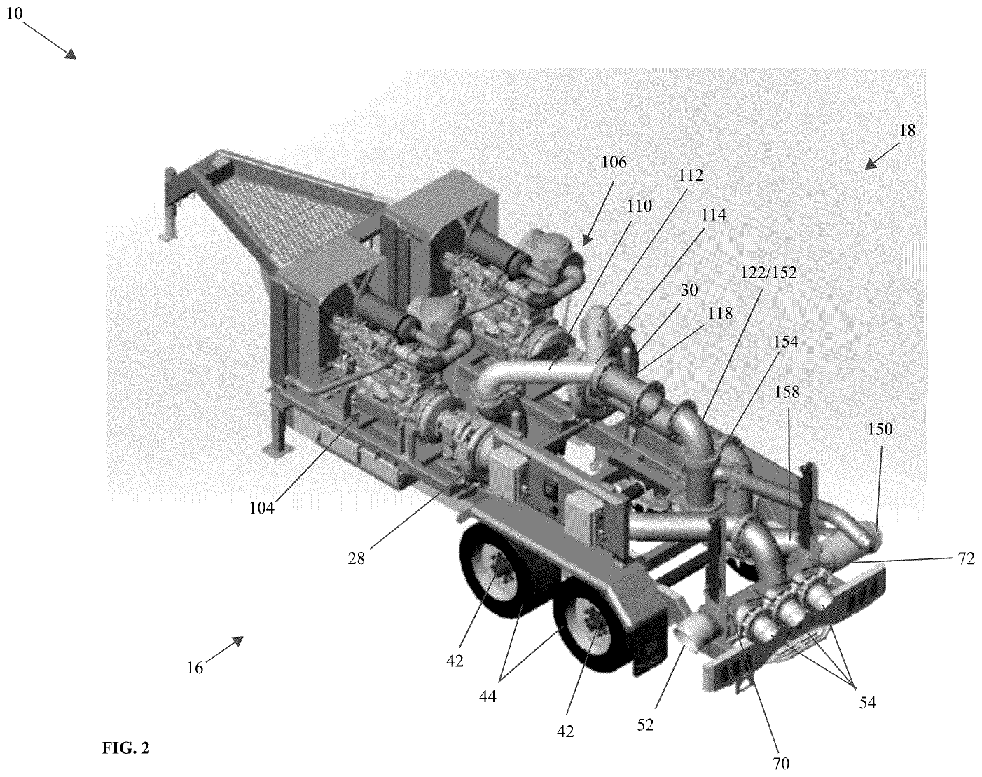

FIG. 3 is another perspective view of a dual engine parallel pumping trailer system, in accordance with one or more arrangements; the view showing the system having a trailer, a liquid inlet system, a first pump connected to a first engine, a second pump connected to a second engine, a liquid outlet system, and a control system; the view showing a first conduit running from the liquid inlet system to the first pump, and a second conduit running from the liquid inlet system to the second pump; the view showing a first tube running from the first pump to the liquid outlet system and a second tube running from the second pump to the liquid outlet system; the view also showing the control system having a master control system, a first control system, and a second control system.

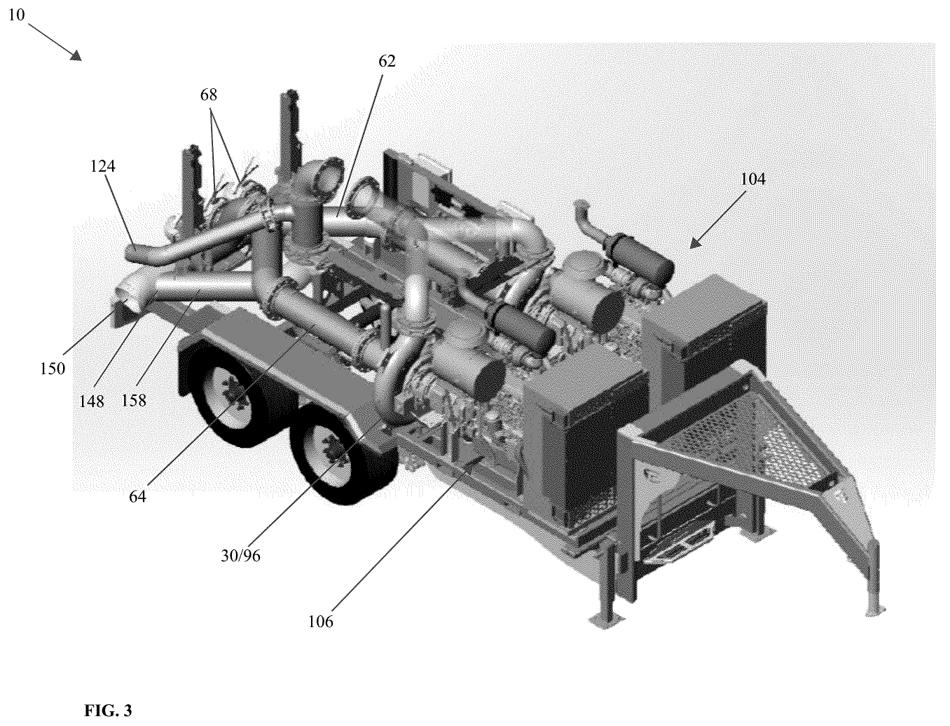

FIG. 4 is another perspective view of a dual engine parallel pumping trailer system, in accordance with one or more arrangements; the view showing the system having a trailer, a liquid inlet system, a first pump connected to a first engine, a second pump connected to a second engine, a liquid outlet system, and a control system; the view showing a first conduit running from the liquid inlet system to the first pump, and a second conduit running from the liquid inlet system to the second pump; the view showing a first tube running from the first pump to the liquid outlet system and a second tube running from the second pump to the liquid outlet system; the view also showing the control system having a master control system, a first control system, and a second control system.

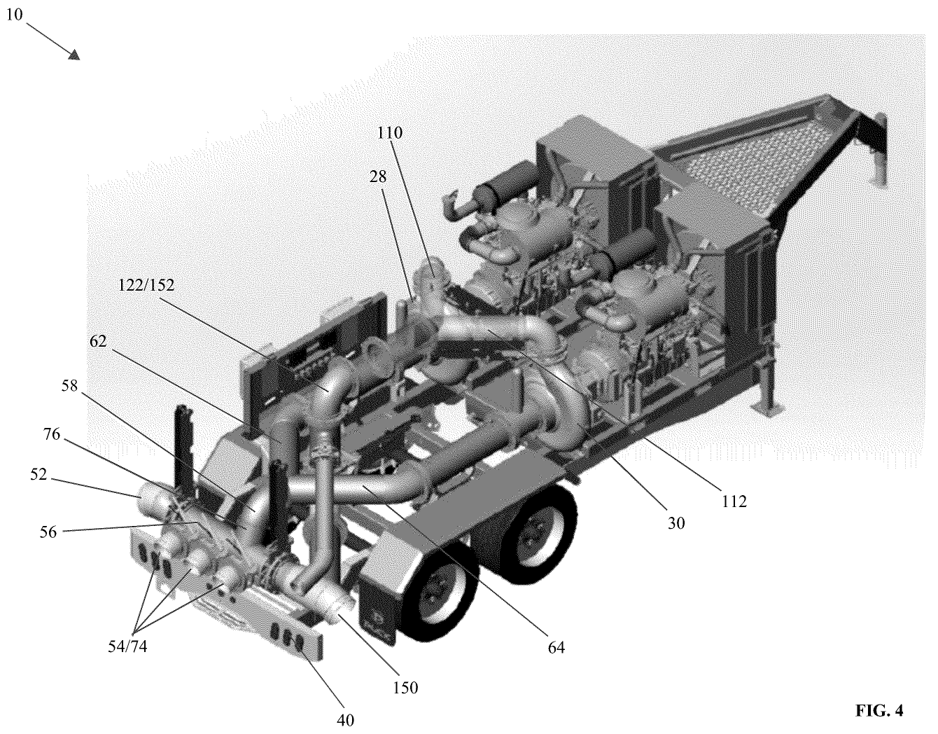

FIG. 5 is a side elevation view of a dual engine parallel pumping trailer system, in accordance with one or more arrangements; the view showing the system having a trailer, a second conduit running from a liquid inlet system to a second pump, a second tube running from the second pump to a liquid outlet system; the view showing the liquid outlet system having a coupling, a flow sensor, and an outlet tube.

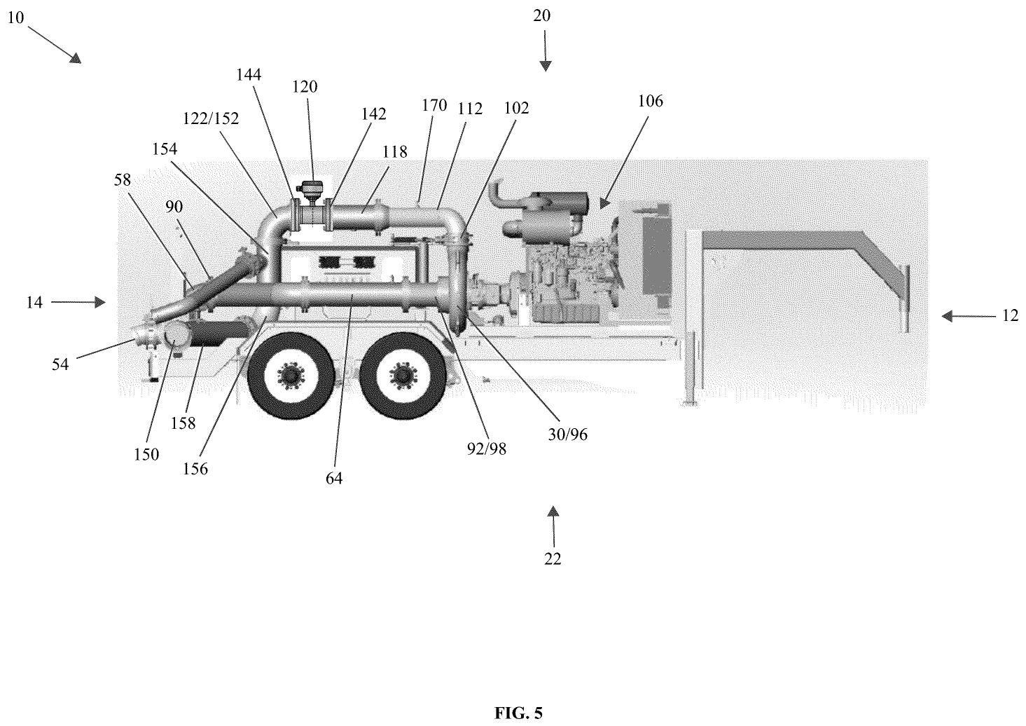

FIG. 6 is another side elevation view of a dual engine parallel pumping trailer system, in accordance with one or more arrangements; the view showing the system having a trailer, a first conduit running from a liquid inlet system to a first pump, a first tube running from the first pump to a liquid outlet system; the view showing the liquid inlet system having a hose inlet and reservoir inlets.

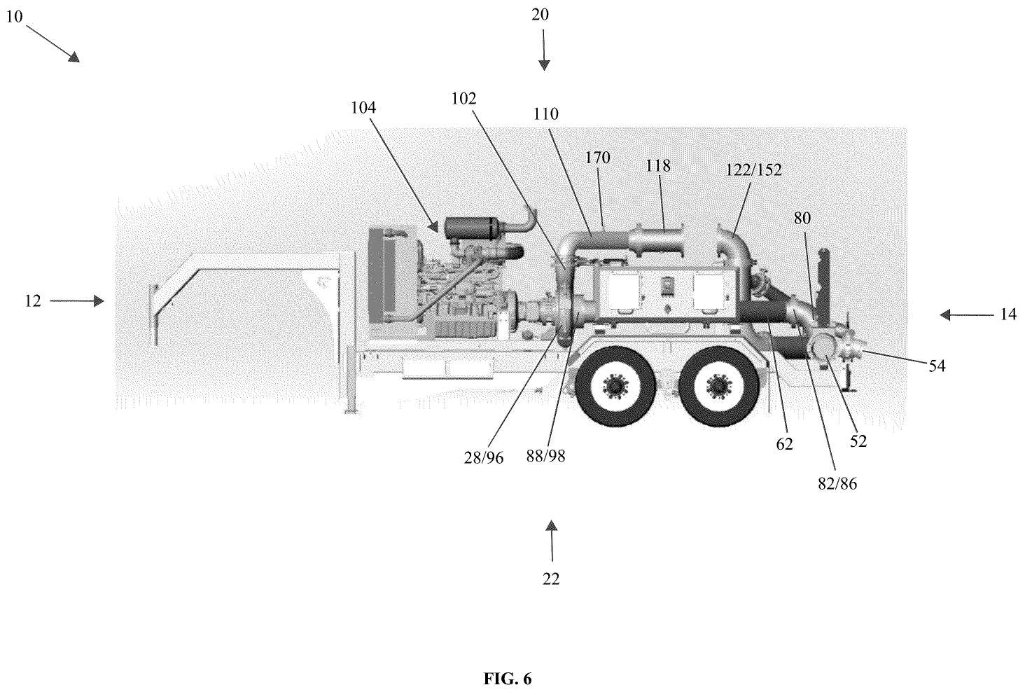

FIG. 7 is an elevation view of the intersection of the first tube and the second tube, in accordance with one or more arrangements; the view showing the first tube having a first end and an opening; the view showing the second tube having a first end and an opening; the view also showing a baffle at the intersection of the first tube and the second tube.

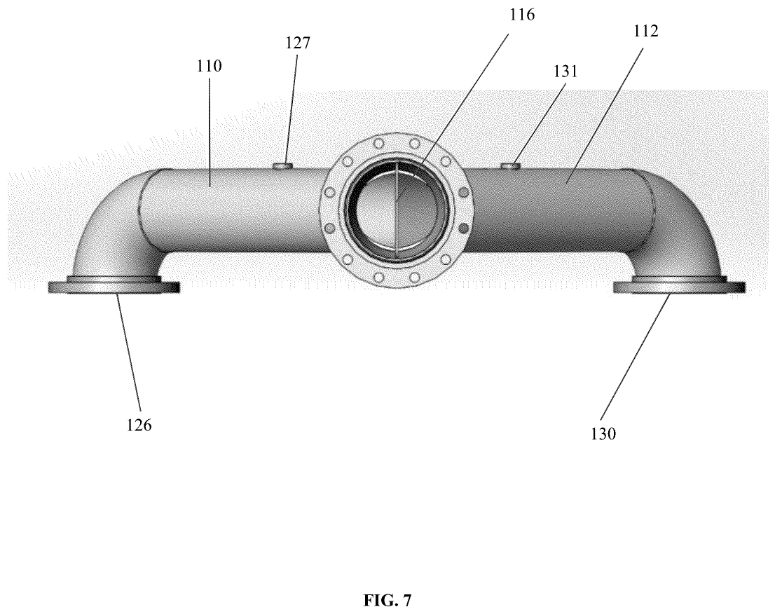

FIG. 8 is a perspective view of the intersection of the first tube and the second tube, in accordance with one or more arrangements; the view showing the first tube and the second tube partially cut away; the view showing a second end of the first tube and a second end of the second tube meeting at an intersection; the view showing a baffle placed at the intersection and the baffle having a fixed end which meets with the second end of the first tube and the second end of the second tube.

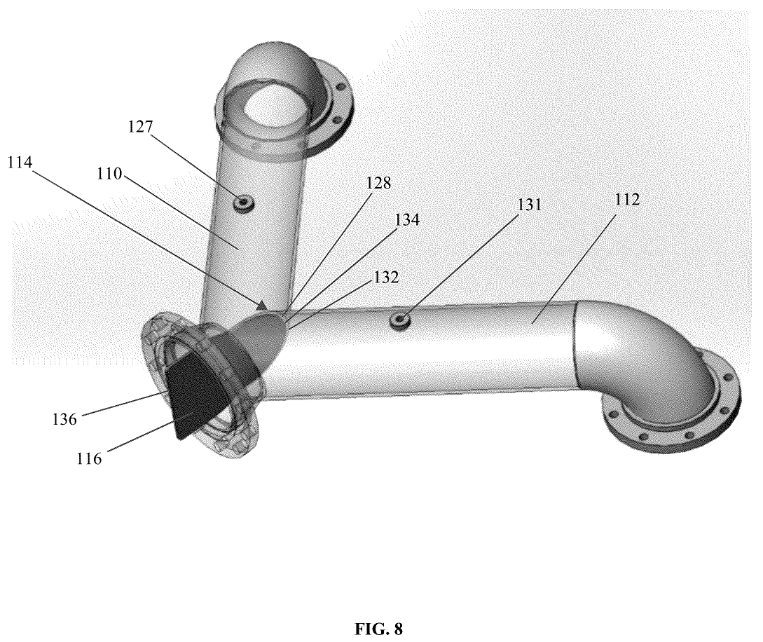

FIG. 9 is a side elevation view of the intersection of the first tube and the second tube, in accordance with one or more arrangements; the view showing the first tube having a gate; the view showing the first tube meeting a coupling of a liquid outlet system.

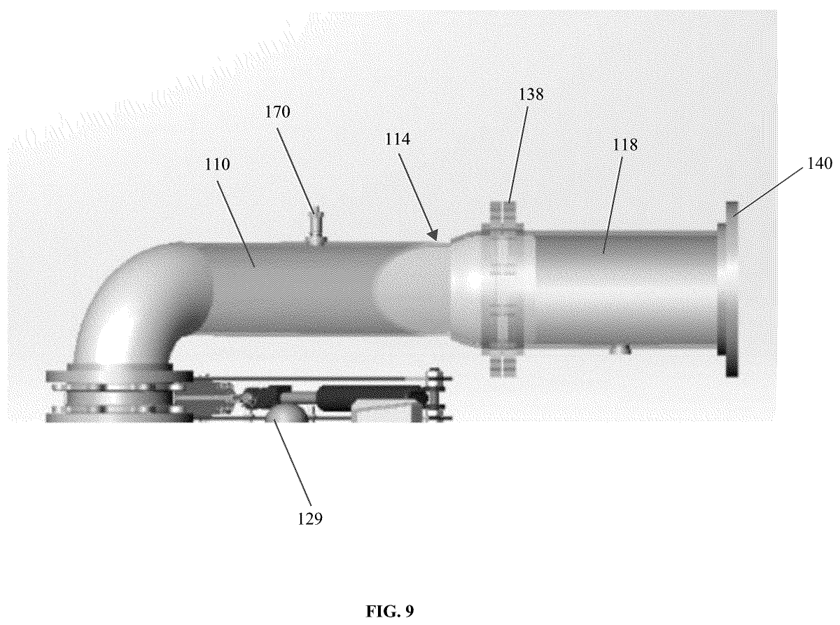

FIG. 10 is a diagram of the control system; the view showing the control system comprised of a master control system, a first control system, and a second control system, in accordance with one or more arrangements; the view showing the master control system having a microprocessor, a memory, and instructions; the view showing the first control system having a microprocessor, a memory, and instructions; the view also showing the second control system having a microprocessor, a memory, and instructions.

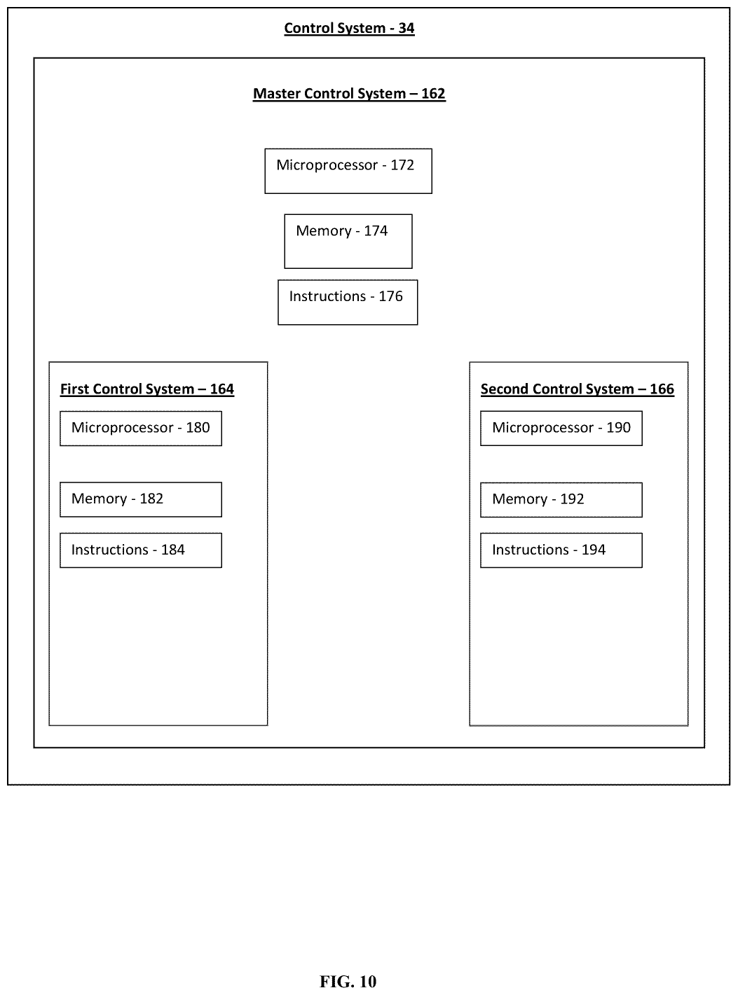

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled, ” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of pumping liquids. However, the embodiments are not so limited. It is appreciated that the embodiments may be adapted for use in other applications which may be improved by the disclosed structures, arrangements and/or methods. The system is merely shown and described as being used in the context of pumping liquids for ease of description and as one of countless examples.

### Dual Engine Parallel Pumping Trailer System

With reference to the figures, a dual engine parallel pumping trailer system (or simply “system 10”) is presented. System 10 is formed of any suitable size, shape, and design and is configured to increase the flow rate (measured, by way of example and not limitation, in gallons per minute) of liquid flowing through the system. In the arrangement shown, as one example, system 10 has a forward end 12, a rearward end 14, a first side 16, a second side 18, a top side 20, and a bottom side 22. In the arrangement shown, as one example, system 10 includes a trailer 24, a liquid inlet system 26, a first pump 28 and a second pump 30, a liquid outlet system 32, and a control system 34, among other components as described herein. While system 10 has been described according to the arrangement shown, as one example, any combination or arrangement may be used and is hereby contemplated for use.

### Trailer

In the arrangement shown, as one example, system 10 includes trailer 24. Trailer 24 is formed of any suitable size, shape, and design and is configured to support various components of system 10 and allow for system 10 to be quickly and conveniently moved to desired locations. In the arrangement shown, as one example, trailer 24 includes a tongue 38, a frame 40, axles 42, wheels 44, and jacks 46, among other components as described herein. In the arrangement shown, as one example, trailer 24 is an uncovered gooseneck (or fifth wheel) dual axle trailer. However, trailer 24 is not so limited and any other types or configurations of trailers may be used and are hereby contemplated for use as trailer 24 including, by way of example and not limitation, a flatbed trailer, an enclosed trailer, a low-boy trailer, a tilt trailer, or any other type or configuration of trailer.

Tongue: In the arrangement shown, as one example, trailer 24 includes tongue 38. Tongue 38 is formed of any suitable size, shape, and design and is configured to facilitate connection of trailer 24 to a vehicle in order to transport system 10 to desired locations. In the arrangement shown, as one example, tongue 38 includes a hitch 48 configured to facilitate the connection of trailer 24 to a vehicle. In the arrangement shown, as one example, tongue 38 extends from the frame 40 of trailer 24 forward to hitch 48, which is located at the forward end 12 of system 10.

Frame: In the arrangement shown, as one example, trailer 24 includes frame 40. Frame 40 is formed of any suitable, size, shape, and design and is configured to support various components of system 10. In the arrangement shown, as one example, frame 40 may be formed of a plurality of rails extending across trailer 24 (from side to side of trailer 24 and/or from front to back of trailer 24) which, in combination, create an effective surface on which various components of system 10 rest. In alternative arrangements, as examples, frame 40 may include a trailer bed upon which various components of system 10 may rest. In further alternative arrangements, frame 40 may be any combination of a trailer bed and rails configured to create surfaces upon which various components of system 10 rest, or frame 40 may be formed of any other suitable design and configuration in order to support various components of system 10.

In the arrangement shown, as one example, frame 40 also connects the various components of trailer 24. That is, in the arrangement shown as one example, frame 40 connects to tongue 38, as well as to axles 42, wheels 44, and jacks 46.

Axles: In the arrangement shown, as one example, trailer 24 includes axles 42. Axles 42 are formed of any suitable size, shape, and design and are configured to facilitate movement of trailer 24. In the arrangement shown, as one example, axles 42 extend between opposing ends (not shown), with one opposing end at or near the first side 16 of system 10 and the other opposing end at or near the second side 18 of system 10. In the arrangement shown, as one example, trailer 24 includes dual axles 42, however any other number of axles may be used, including one, two, three, four, five, or more axles 42 in order for trailer 24 to effectively support system 10 and the movement of system 10.

In the arrangement shown, as one example, axles 42 operably connect wheels 44 to frame 40. That is, in the arrangement shown, as one example, axles 42 connect to both frame 40 and wheels 44, thereby operably connecting wheels 44 to frame 40.

Wheels: In the arrangement shown, as one example, trailer 24 includes wheels 44. Wheels 44 are formed of any suitable size, shape, and design and are configured to facilitate movement of trailer 24. Wheels 44 are standard wheels which are well known by those of skill in the art. Wheels 44 may be formed of any type of wheel and may include any combination of components included in wheels used in the art. Additionally, wheels 44 function in the same way as those wheels known to those of skill in the art. In the arrangement shown, as one example, a wheel 44 is connected to the opposing ends of axles 42. In the arrangement shown, as one example, with dual axles 42, there are four wheels 44, one at each of the opposing ends of the dual axles 42. In various alternative arrangements, any other number of wheels 44 may be used, and any number of wheels 44 may be connected to the opposing ends of axles 42 in order for trailer 24 to effectively support system 10 and the movement of system 10. That is, in various alternative arrangements, each axle 42 may have one, two, or more wheels connected to each opposing end of said axle 42.

Jacks: In the arrangement shown, as one example, wheels 44 facilitate the movement of system 10, however it is not always desired that system 10 be movable. Therefore, in the arrangement shown, as one example, trailer 24 include jacks 46. Jacks 46 are formed of any suitable size, shape, and design and are configured to help facilitate stability and support of trailer 24 when trailer 24 is not moving. Jacks 46 may be any trailer jacks, or any other type of jack, which are known by those of skill in the art and jacks 46 may be manual, hydraulic, electric, or otherwise powered.

In the arrangement shown, as one example, jacks 46 also help facilitate the connection of trailer 24 to a vehicle. That is, jacks 46 help to raise or lower trailer 24 such that the hitch 48 of tongue 38 is able to properly connect to the vehicle. In this way, jacks 46 also help facilitate the connection of trailer 24 to a vehicle.

While trailer 24 has been described according the arrangement shown, as one example, it will be understood by those skilled in the art that any other configuration of trailer 24 may be used, and is hereby contemplated for use, in order to support various components of system 10 and allow for system 10 to be quickly and conveniently moved to desired locations.

In the arrangement shown, as one example, the liquid inlet system 26, first pump 28, second pump 30, liquid outlet system 32, and various components of control system 34 rest on top of, or are effectively supported by, trailer 24.

### Liquid Inlet System

In the arrangement shown, as one example, system 10 includes liquid inlet system 26. Liquid inlet system 26 is formed of any suitable size, shape, and design and is configured to allow liquid to enter system 10 and flow to first pump 28 and second pump 30. In the arrangement shown, as one example, liquid inlet system 26 operably connects to trailer 24 and is positioned near the rearward end 14 of system 10, with at least a portion of liquid inlet system 26 extending past the rear end of frame 40 of trailer 24. In the arrangement shown, as one example, liquid inlet system 26 includes a hose inlet 52, reservoir inlets 54, a first coupling 56, a second coupling 58, an intersection 60, a first conduit 62, and a second conduit 64. In the arrangement shown, as one example, liquid may enter system 10 through either hose inlet 52 or reservoir inlet 54

Hose Inlet: In the arrangement shown, as one example, liquid inlet system 26 includes hose inlet 52. Hose inlet 52 is formed of any suitable size, shape, and design and is configured to allow liquid to travel through a hose or pipe and into system 10. In the arrangement shown, as one example, hose inlet 52 is a hose fitting or similar connection member which allows system 10 to connect to a hose or pipe and liquid can flow from said hose or pipe into and through hose inlet 52. In the arrangement shown, as one example, hose inlet 52 is connected to the first coupling 56 of liquid inlet system 26, which operably connects hose inlet 52 with the remainder of liquid inlet system 26 and system 10. With hose inlet 52 operably connected to system 10, liquid may enter system 10 via a hose or pipe through hose inlet 52.

In the arrangement shown, as one example, hose inlet 52 may be a 12-inch diameter hook-up configured to connect to a 12-inch diameter lay-flat hose, however any other size or configuration of hose inlet 52 may be used. In the arrangement shown, as one example, hose inlet 52 includes a gate 66. Gate 66 is formed of any suitable size, shape, and design and is configured to control the flow of liquid through hose inlet 52, such as may be desired when, in the arrangement shown as one example, using only reservoir inlets 54. In the arrangement shown, as one example, gate 66 is a hydraulic knife gate which is capable of being controlled remotely or manually, however any other type of gate, valve, shut-off, or cut-off controlled either remotely or manually may be used as gate 66. In the arrangement shown, as one example, liquid may enter system 10 through reservoir inlets 54. When liquid is entering system 10 through only reservoir inlets 54, liquid may inadvertently flow out of hose inlet 52. In order to prevent this, gate 66 is provided and gate 66 can be closed when only reservoir inlets 54 are in use, thereby preventing liquid from flowing out of system 10 through hose inlet 52.

Reservoir Inlets: In the arrangement shown, as one example, liquid inlet system 26 includes reservoir inlets 54. Reservoir inlets 54 are formed of any suitable size, shape, and design and are configured to allow liquid to enter system 10. In the arrangement shown, as one example, reservoir inlets 54 are positioned at the rearward end 14 and the reservoir inlets 54 are fittings or similar connection members which are configured to connect to hoses or pipes. In the arrangement shown, as one example, the hoses or pipes connected to the reservoir inlets 54 may be inserted into a reservoir and liquid from the reservoir may be pumped into system 10 through reservoir inlets 54. In the arrangement shown, as one example, reservoir inlets 54 are connected to first coupling 56, which operably connects reservoir inlets 54 to the remainder of liquid inlet system 26 and system 10. With reservoir inlets 54 operably connected to system 10, liquid may enter system 10 through reservoir inlets 54.

In the arrangement shown, as one example, there are three reservoir inlets 54, however any other number of reservoir inlets 54 may be used in liquid inlet system 26. In the arrangement shown, as one example, reservoir inlets 54 are 8-inch diameter hook-ups configured to connect to 8-inch diameter hoses or pipes, however any other size or configuration of reservoir inlets 54 may be used. In the arrangement shown, as one example, reservoir inlets 54 include valves 68. Valves 68 are formed of any suitable size, shape, and design and are configured to control the flow of liquid through reservoir inlets 54, such as may be desired when, in the arrangement shown as one example, using only hose inlet 52 or only one or two reservoir inlets 54. In the arrangement shown, as one example, valves 68 are a lever butterfly valve, however valves 68 may be a ball valve, a plug valve, or any other type of gate, valve, shut-off, or cut-off controlled either remotely or manually. In the arrangement shown, as one example, liquid may enter system 10 through only hose inlet 52, or through only one or two reservoir inlets 54, or any other number less than the total number of reservoir inlets 54. In such arrangements, liquid may inadvertently flow out of one or more reservoir inlets 54. In order to prevent this, valves 68 are provided and one or more valves 68 may be closed at a given time, thereby preventing liquid from flowing out of system 10 through one or more reservoir inlets 54.

In the arrangement shown, as one example, both hose inlet 52 and reservoir inlets 54 are connected to first coupling 56 of liquid inlet system 26.

First Coupling: In the arrangement shown, as one example, liquid inlet system 26 includes first coupling 56. First coupling 56 is formed of any suitable size, shape, and design and is configured to operably connect hose inlet 52 and reservoir inlets 54 to the remainder of liquid inlet system 26 and system 10. In the arrangement shown, as one example, first coupling 56 is a generally cylindrical and hollow member extending a length between a first end 70 and a second end 72. In the arrangement shown, as one example, first coupling 56 includes a plurality of openings 74 and an upper extension 76.

In the arrangement shown as one example, first coupling 56 may be formed of a single, unitary member that is formed in a manufacturing process such as machining, additive manufacturing, casting, extrusion, or the like to form a unitary and monolithic member. Alternatively, first coupling 56 may be formed of multiple pieces that are connected or assembled to one another through welding or any other process of connecting multiple components together. In the arrangement shown, as one example, first coupling 56 is formed primarily of a metallic material such as steel, aluminum, chromium, or any other metallic material, alloy, and/or composite thereof. Alternatively, first coupling 56 may be formed of a non-metallic material such as a plastic material, a fiberglass material, or any other non-metallic material and/or composite thereof.

In the arrangement shown, as one example, first end 70 of first coupling 56 connects to hose inlet 52. In the arrangement shown, as one example, second end 72 of first coupling 56 connects to hose outlet 150 of outlet tube 122 of liquid outlet system 32. In the arrangement shown, as one example, second end 72 of first coupling 56 also includes a gate 78. Gate 78 is formed of any suitable size, shape, and design and is configured to control the flow of liquid through second end 72 of first coupling 56. In the arrangement shown, as one example, gate 78 is a hydraulic knife gate which is capable of being controlled remotely or manually, however any other type of gate, valve, shut-off or cut-off controlled either remotely or manually may be used as gate 78. In the arrangement shown, as one example, gate 78 will generally be closed when system 10 is operated, so that no liquid may exit the liquid inlet system 26 through second end 72 of first coupling 56. However, in certain situations system 10 may serve as a passthrough and/or as a means to simply connect two hoses or pipes, and in such situations gate 78 may be opened such that liquid may flow into hose inlet 52, through both the first end 70 and second end 72 of first coupling 56, and out of system 10 through hose outlet 150 of outlet tube 122 of liquid outlet system 32.

In the arrangement shown, as one example, first coupling 56 includes a plurality of openings 74. Plurality of openings 74 are formed of any suitable size, shape, and design and are configured to connect to reservoir inlets 54. In the arrangement shown, as one example, plurality of openings 74 are shaped and sized to be complimentary to reservoir inlets 54. Additionally, in the arrangement shown as one example, there are the same number of openings 74 as there are reservoir inlets 54, thereby allowing for connection of each of the reservoir inlets 54 to the first coupling 56.

In the arrangement shown, as one example, first coupling 56 includes upper extension 76. Upper extension 76 is formed of any suitable size, shape, and design and is configured to facilitate fluid connection between first coupling 56 and second coupling 58. In the arrangement shown, as one example, upper extension 76 is a generally cylindrical and hollow member which extends upward from, and is in fluid connection with, the main cylindrical body of first coupling 56. In the arrangement shown, as one example, upper extension 76 connects to second coupling 58 at the upper end of upper extension 76, thereby facilitating fluid connection between first coupling 56 and second coupling 58.

Second Coupling: In the arrangement shown, as one example, liquid inlet system 26 includes a second coupling 58. Second coupling 58 is formed of any suitable size, shape, and design and is configured to facilitate fluid connection between first coupling 56 and first conduit 62 and second conduit 64. In the arrangement shown, as one example, second coupling 58 is a generally cylindrical, hollowed, and angled member which extends from a first end 80 to a second end 82.

In the arrangement shown as one example, second coupling 58 may be formed of a single, unitary member that is formed in a manufacturing process such as machining, additive manufacturing, casting, extrusion, or the like to form a unitary and monolithic member. Alternatively, second coupling 58 may be formed of multiple pieces that are connected or assembled to one another through welding or any other process of connecting multiple components together. In the arrangement shown, as one example, second coupling 58 is formed primarily of a metallic material such as steel, aluminum, chromium, or any other metallic material, alloy, and/or composite thereof. Alternatively, second coupling 58 may be formed of a non-metallic material such as a plastic material, a fiberglass material, or any other non-metallic material and/or composite thereof.

In the arrangement shown, as one example, the first end 80 of second coupling 58 connects to the upper extension 76 of first coupling 56, thereby facilitating fluid connection between first coupling 56 and second coupling 58. In the arrangement shown, as one example, second end 82 of second coupling 58 connects at intersection 60 to first conduit 62 and second conduit 64, thereby facilitating fluid connection between second coupling 58 and first conduit 62 and second conduit 64. In the arrangement shown, as one example, when second coupling 58 is connected to both first coupling 56 and at intersection 60 to first conduit 62 and second conduit 64, second coupling 58 facilitates operable fluid connection between hose inlet 52, reservoir inlets 54, first coupling 56, and first conduit 62 and second conduit 64.

Intersection: In the arrangement shown, as one example, first conduit 62 and second conduit 64 connect to second coupling 58 at intersection 60. In the arrangement shown, as one example, intersection 60 is generally in the shape of a “Y.” More specifically, in the arrangement shown, as one example, second coupling 58 comes into intersection 60 from near the rearward end 14 of system 10 at approximately a 90-degree angle. In the arrangement shown, as one example, first conduit 62 and second conduit 64 each extend outward from intersection 60 toward the forward end 12 of system 10, with first conduit 62 extending at approximately a 45-degree angle toward the first side 16 of system 10 and second conduit 64 extending at approximately a 45-degree angle toward the second side 18 of system 10.

First Conduit: In the arrangement shown, as one example, liquid inlet system 26 includes first conduit 62. First conduit 62 is formed of any suitable size, shape, and design and is configured to facilitate fluid connection between liquid inlet system 26 and first pump 28. In the arrangement shown, as one example, first conduit 62 is a generally cylindrical and hollow member which extends a length between a first end 86 and a second end 88. In the arrangement shown, as one example, first end 86 of first conduit 62 connects to second coupling 58 and second conduit 64 at intersection 60. In the arrangement shown, as one example, second end 88 of first conduit 62 connects to the inlet 98 of first pump 28. In the arrangement shown, as one example, first conduit 62 includes an opening 89 (not shown) which is configured to receive one of the plurality of pressure sensors 170 of master control system 162 of control system 34.

In the arrangement shown as one example, first conduit 62 is formed of multiple pieces that are connected or assembled to one another through welding, bolting, screwing, riveting, or a similar process. Alternatively, first conduit 62 may be formed of a single, unitary member that is formed in a manufacturing process such as machining, additive manufacturing, casting, extrusion, or the like to form a unitary and monolithic member. In the arrangement shown, as one example, first conduit 62 is formed primarily of a metallic material such as steel, aluminum, chromium, or any other metallic material, alloy, and/or composite thereof. Alternatively, first conduit 62 may be formed of a non-metallic material such as a plastic material, a fiberglass material, or any other non-metallic material and/or composite thereof.

Second Conduit: In the arrangement shown, as one example, liquid inlet system 26 includes second conduit 64. Second conduit 64 is formed of any suitable size, shape, and design and is configured to facilitate fluid connection between liquid inlet system 26 and second pump 30. In the arrangement shown, as one example, second conduit 64 is a generally cylindrical and hollow member which extends a length between a first end 90 and a second end 92. In the arrangement shown, as one example, first end 90 of second conduit 64 connects to second coupling 58 and first conduit 62 at intersection 60. In the arrangement shown, as one example, second end 92 of second conduit 64 connects to the inlet 98 of second pump 30. In the arrangement shown, as one example, second conduit 64 includes an opening 94 (not shown) which is configured to receive one of the plurality of pressure sensors 170 of master control system 162 of control system 34.

In the arrangement shown as one example, second conduit 64 is formed of multiple pieces that are connected or assembled to one another through welding, bolting, screwing, riveting, or a similar process. Alternatively, second conduit 64 may be formed of a single, unitary member that is formed in a manufacturing process such as machining, additive manufacturing, casting, extrusion, or the like to form a unitary and monolithic member. In the arrangement shown, as one example, second conduit 64 is formed primarily of a metallic material such as steel, aluminum, chromium, or any other metallic material, alloy, and/or composite thereof. Alternatively, second conduit 64 may be formed of a non-metallic material such as a plastic material, a fiberglass material, or any other non-metallic material and/or composite thereof.

As described herein, the various components of liquid inlet system 26 are in fluid connection with each other, such that liquid can flow through the entirety of liquid inlet system 26 to first pump 28 and second pump 30. In the arrangement shown as one example, liquid enters system 10 through either hose inlet 52 or reservoir inlets 54. Liquid can then flow through first coupling 56 and through second coupling 58 until it reaches intersection 60. At intersection 60, the liquid splits into a first portion of liquid and a second portion of liquid, which flow in parallel through first conduit 62 and second conduit 64, respectively. That is, the first portion of liquid then flows through the first conduit 62 until it reaches first pump 28 and, simultaneously (i.e. in a parallel flow manner), the second portion of liquid flows through the second conduit 64 until it reaches second pump 30.

While liquid inlet system 26 and its various components have been described according to the arrangements shown, as examples, it will be understood by those skilled in the art that any other arrangement or configuration of liquid inlet system 26 and its various components may be used in order to allow liquid to enter system 10 and flow to first pump 28 and second pump 30.

### Pair of Pumps

In the arrangement shown, as one example, system 10 includes a pair of pumps consisting of first pump 28 and a second pump 30. First pump 28 and second pump 30 are formed of any suitable size, shape, and design and are configured to pump liquid through system 10, and increase the velocity and pressure at which liquid moves through system 10. In the arrangement shown, as one example, first pump 28 and second pump 30 are 2,100 gallon per minute centrifugal impeller pumps, however any other type, configuration, or size of pump may be used as first pump 28 and second pump 30. In the arrangement shown as one example, first pump 28 and second pump 30 are any number of centrifugal impeller pumps known in the art, and such pumps generally include a housing 96, an inlet 98, an impeller (not shown), and an outlet 102.

Housing: In the arrangement shown, as one example, first pump 28 and second pump 30 include a housing 96. Housing 96 is formed of any suitable size, shape, and design and is configured to enclose portions of first pump 28 and second pump 30. In the arrangement shown, as one example, housing 96 is formed of multiple pieces that are connected or assembled to one another such as through welding, screwing, bolting, friction fitting, or the like. In the arrangement shown, as one example, housing 96 is formed of a metallic material such as steel, aluminum, chromium, or any other metallic material, alloy, and/or composite thereof. Alternatively, housing 96 may be formed of a non-metallic material such as a plastic material, a fiberglass material, or any other non-metallic material and/or composite thereof.

Inlet: In the arrangement shown, as one example, first pump 28 and second pump 30 include an inlet 98. Inlet 98 is formed of any suitable size, shape, and design and is configured to connect to first conduit 62 and/or second conduit 64 and allow liquid to enter first pump 28 and second pump 30. In the arrangement shown, as one example, inlet 98 may be generally circular in shape and are sized such that they coincide with, and are generally the same size as, first conduit 62 and second conduit 64. In the arrangement shown, as one example, as liquid flows through the second end 88 of first conduit 62 and/or the second end 92 of second conduit 64, liquid flows through the respective inlet 98 of first pump 28 and/or second pump 30.

Impeller: In the arrangement shown, as one example, first pump 28 and second pump 30 include an impeller (not shown). The impeller is formed of any suitable size, shape, and design and is configured to rotate within the housing 96 and, thereby, force liquid toward outlet 102 at an increased velocity and pressure. In the arrangement shown, as one example, liquid enters first pump 28 and second pump 30 through their inlets 98, and inlets 98 are generally colinear with the axis of rotation of the impeller. As the impellers are rotating and liquid enters inlets 98, liquid is forced toward the walls of housing 96. As the liquid is forced toward the walls of housing 96, the liquid increases in velocity and pressure and finally flows out of the outlets 102 of first pump 28 and/or second pump 30.

Outlet: In the arrangement shown, as one example, first pump 28 and second pump 30 include an outlet 102. Outlet 102 is formed of any suitable size, shape, and design and is configured to allow liquid to exit first pump 28 and second pump 30 and enter into first tube 110 and/or second tube 112 of liquid outlet system 32. In the arrangement shown, as one example, outlet 102 is generally circular in shape, however outlet 102 may be formed of any other size, shape, and design. In the arrangement shown, as one example, outlet 102 is generally sized and shaped to coincide with first tube 110 and second tube 112 of liquid outlet system 32.

Pair of Engines: In the arrangement shown, as one example, first pump 28 is connected to a first engine 104 and second pump 30 is connected to a second engine 106. First engine 104 and second engine 106 are formed of any suitable size, shape, and design and are configured to provide power to first pump 28 and second pump 30, respectively, in order to cause the impeller to rotate at a desired revolutions per minute (RPMs). In the arrangement shown, as one example, first engine 104 and second engine 106 are 325 horsepower gas-powered engines, however any other type and size of engine or motor may be used in order to power first pump 28 and second pump 30, including a battery-powered engine, a solar powered engine, a hydrostatically driven motor, an electric motor, or any other type of engine, motor, or power source.

In the arrangement shown, as one example, liquid flows into system 10 and through liquid inlet system 26, where it splits into a first portion of liquid and a second portion of liquid as described herein. The first portion of liquid flows through first conduit 62 and enters inlet 98 of first pump 28 and the second portion of liquid flows through second conduit 64 and enters inlet 98 of second pump 30. At this point, first engine 104 is providing power to first pump 28 and second engine 106 is providing power to second pump 30, thereby facilitating the rotation of the impeller in each of the first pump 28 and second pump 30. As liquid flows into the inlets 98 of first pump 28 and second pump 30, respectively, the rotation of the impellers forces the liquid toward the walls of housing 96 and, in the process, increases the velocity and pressure of the liquid. As the liquid is forced to the walls of housing 96, the liquid flows out of the first pump 28 and second pump 30, through outlets 102, and into first tube 110 and second tube 112, respectively, of liquid outlet system 32.

While first pump 28 and second pump 30 have been described according the arrangements shown, as examples, it will be understood by those skilled in the art that any other configuration of first pump 28 and/or second pump 30 may be used in order to pump liquid through system 10, and increase the velocity and pressure at which liquid moves through system 10.

### Liquid Outlet System

In the arrangement shown, as one example, system 10 includes liquid outlet system 32. Liquid outlet system 32 is formed of any suitable size, shape, and design and is configured to connect to first pump 28 and second pump 30 and expel liquid from system 10. In the arrangement shown, as one example, liquid outlet system 32 includes a first tube 110, a second tube 112, an intersection 114, a baffle 116, a coupling 118, a flow meter 120, an outlet tube 122, and a recirculation pipe 124.

First Tube: In the arrangement shown, as one example, liquid outlet system 32 includes first tube 110. First tube 110 is formed of any suitable size, shape, and design and is configured to facilitate fluid connection between first pump 28 and liquid outlet system 32. In the arrangement shown, as one example, first tube 110 is a generally cylindrical and hollow member which extends a length between a first end 126 and a second end 128. In the arrangement shown, as one example, first tube 110 is a tube with an 8-inch diameter, however any other size tube may be used as first tube 110. In the arrangement shown, as one example, first end 126 of first tube 110 connects to the outlet 102 of first pump 28. In the arrangement shown, as one example, second end 128 of first tube 110 connects to both second tube 112 and coupling 118 at intersection 114. In the arrangement shown, as one example, first tube 110 includes an opening 127 which is configured to receive one of the plurality of pressure sensors 170 of master control system 162 of control system 34.

In the arrangement shown as one example, first tube 110 is formed of a single, unitary member that is formed in a manufacturing process such as machining, additive manufacturing, casting, extrusion, or the like to form a unitary and monolithic member. Alternatively, first tube 110 may be formed of multiple pieces that are connected or assembled to one another through welding, bolting, screwing, riveting, or a similar process. In the arrangement shown, as one example, first tube 110 is formed primarily of a metallic material such as steel, aluminum, chromium, or any other metallic material, alloy, and/or composite thereof. Alternatively, first tube 110 may be formed of a non-metallic material such as a plastic material, a fiberglass material, or any other non-metallic material and/or composite thereof.

In the arrangement shown, as one example, first tube 110 includes a gate 129. Gate 129 is formed of any suitable size, shape, and design and is configured to control the flow of liquid through first tube 110. In the arrangement shown, as one example, gate 129 is placed at the first end 126 of first tube 110 such that it can control the flow of liquid from first pump 28 into first tube 110. In the arrangement shown, as one example, gate 129 is a hydraulic knife gate which is capable of being controlled remotely or manually, however any other type of gate, valve, shut-off, or cut-off controlled either remotely or manually may be used as gate 129. In the arrangement shown, as one example, it may be desired that system 10 run using only second pump 30. In this situation, as one example, gate 129 may be closed such that no liquid flows through first tube 110 and, similarly, no liquid flows through first pump 28. In other situations, it may be desired that less liquid flow through first pump 28 than second pump 30, therefore gate 129 may be partially closed to inhibit the flow of liquid through first tube 110 and, similarly inhibit the flow of liquid through first pump 28.

Second Tube: In the arrangement shown, as one example, liquid outlet system 32 includes second tube 112. Second tube 112 is formed of any suitable size, shape, and design and is configured to facilitate fluid connection between second pump 30 and liquid outlet system 32. In the arrangement shown, as one example, second tube 112 is a generally cylindrical and hollow member which extends a length between a first end 130 and a second end 132. In the arrangement shown, as one example, second tube 112 is a tube with an 8-inch diameter, however any other size tube may be used as second tube 112. In the arrangement shown, as one example, first end 130 of second tube 112 connects to the outlet 102 of second pump 30. In the arrangement shown, as one example, second end 132 of second tube 112 connects to both first tube 110 and coupling 118 at intersection 114. In the arrangement shown, as one example, second tube 112 includes an opening 131 which is configured to receive one of the plurality of pressure sensors 170 of master control system 162 of control system 34.

In the arrangement shown as one example, second tube 112 is formed of a single, unitary member that is formed in a manufacturing process such as machining, additive manufacturing, casting, extrusion, or the like to form a unitary and monolithic member. Alternatively, second tube 112 may be formed of multiple pieces that are connected or assembled to one another through welding, bolting, screwing, riveting, or a similar process. In the arrangement shown, as one example, second tube 112 is formed primarily of a metallic material such as steel, aluminum, chromium, or any other metallic material, alloy, and/or composite thereof. Alternatively, second tube 112 may be formed of a non-metallic material such as a plastic material, a fiberglass material, or any other non-metallic material and/or composite thereof.

In the arrangement shown, as one example, second tube 112 includes a gate 133. Gate 133 is formed of any suitable size, shape, and design and is configured to control the flow of liquid through second tube 112. In the arrangement shown, as one example, gate 133 is placed at the first end 130 of second tube 112 such that it can control the flow of liquid from second pump 30 into second tube 112. In the arrangement shown, as one example, gate 133 is a hydraulic knife gate which is capable of being controlled remotely or manually, however any other type of gate, valve, shut-off, or cut-off controlled either remotely or manually may be used as gate 133. In the arrangement shown, as one example, it may be desired that system 10 is run using only first pump 28. In this situation, as one example, gate 133 may be closed such that no liquid flows through second tube 112, and similarly no liquid flows through second pump 30. In other situations, it may be desired that less liquid flow through second pump 30 than first pump 28, therefore gate 133 may be partially closed to inhibit the flow of liquid through second tube 112 and similarly inhibit the flow of liquid through second pump 30.

Intersection: In the arrangement shown, as one example, first tube 110 and second tube 112, as well as coupling 118 converge at intersection 114. In the arrangement shown, as one example, intersection 114 is generally in the shape of a “Y.” More specifically, in the arrangement shown, as one example, first tube 110 and second tube 112 come into intersection 114 from the forward end 12 of system 10, with first tube 110 coming into intersection 114 at approximately a 45-degree angle from the first side 16 of system 10 and second tube 112 coming into intersection 114 at approximately a 45-degrees angle from the second side 18 of system 10. In the arrangement shown, as one example, coupling 118 extends outward from intersection 114 toward the rearward end 14 of system 10. While intersection 114 has been shown and described as having the general shape of a “Y” and including angles of approximately 45-degrees, intersection 114 is not so limited. In various other arrangements, as examples, intersection 114 may take any other form, shape, or design, and include any other angles to form such shape or design, in order to create a space where first tube 110, second tube 112, and coupling 118 converge and allow the first portion of liquid and the second portion of liquid to converge while flowing through system 10.

In the arrangement shown, as one example, first tube 110 and second tube 112 are 8-inch diameter tubes, while coupling 118 is a 10-inch diameter tube. Because of this difference in diameter, intersection 114 increases in diameter as it moves from the first side connected to first tube 110 and second tube 112 to the second side connected to coupling 118. This increase in diameter helps allow the first portion of liquid and the second portion of liquid to converge at intersection 114 while not significantly increasing the pressure in system 10 to an undesired pressure.

Baffle: In the arrangement shown, as one example, liquid outlet system 32 includes a baffle 116. Baffle 116 is formed of any suitable size, shape, and design and is configured to smooth the convergence of the flow of liquid at intersection 114 and prevent the first portion of liquid from traveling down second tube 112 and prevent the second portion of liquid from traveling down first tube 110. In the arrangement shown, as one example, baffle 116 is positioned at intersection 114 and is a vertically oriented, planar member which extends a length between a fixed end 134 and a free end 136. In the arrangement shown, as one example, the fixed end 134 of baffle 116 is connected to the interior walls (not shown) at intersection 114, specifically where the interior walls of first tube 110 and second tube 112 meet to form intersection 114. In the arrangement shown, as one example, the free end 136 of baffle 116 is positioned such that it is at least partially housed within the hollow interior of coupling 118.

In the arrangement shown, as one example, baffle 116 is formed of a single, unitary member that is formed in a manufacturing process such as machining, additive manufacturing, casting, extrusion, or the like to form a unitary and monolithic member. Alternatively, baffle 116 may be formed of multiple pieces that are connected or assembled to one another through welding, bolting, screwing, riveting, or a similar process. In the arrangement shown, as one example, baffle 116 is formed primarily of a metallic material such as steel, aluminum, chromium, or any other metallic material, alloy, and/or composite thereof. Alternatively, baffle 116 may be formed of a non-metallic material such as a plastic material, a fiberglass material, or any other non-metallic material and/or composite thereof.

In the arrangement shown, as one example, the first portion of liquid flowing through first tube 110 and the second portion of liquid flowing through second tube 112 converge at intersection 114. In an arrangement without baffle 116, this convergence of liquid would be turbulent as the parallel flows of liquid crash together and try to move into and through coupling 118 simultaneously. Without baffle 116, the first portion of liquid and the second portion of liquid crashing into each other would disrupt the flow of the liquid and decrease the efficiency of system 10. Another issue of having an intersection 114 without baffle 116 is that the first portion of liquid may inadvertently flow down second tube 112 rather than into and through coupling 118. Similarly, the second portion of liquid may inadvertently flow down first tube 110 rather than into and through coupling 118. In order to prevent these issues, baffle 116 is provided in order to smooth the convergence of the flow of liquid at intersection 114 and prevent the first portion of liquid from traveling down second tube 112 and prevent the second portion of liquid from traveling down first tube 110.

Another added benefit placing baffle 116 at intersection 114 is that baffle 116 has been shown to help create a venturi effect that balances the flow of the first portion of liquid and the flow of the second portion of liquid. In the arrangement shown, as one example, the impellers in first pump 28 and second pump 30 may be rotating at different RPMs, which may cause the velocity and pressure of the first portion of liquid and the second portion of liquid to vary. With baffle 116 positioned at intersection 114, baffle 116 helps create a venturi effect which effectively pulls the portion of liquid with the lower velocity and/or pressure and balances the velocity and pressure of that portion of liquid with the other portion of liquid. For instance, by way of example and not limitation, the impeller in first pump 28 may be rotating at a rate that is 200 RPMs slower than the rate of rotation of the impeller in second pump 30. In this instance, normally the second portion of liquid flowing through second tube 112 would have a greater velocity and pressure when it reaches intersection 114. However, with baffle 116 placed at intersection 114, the venturi effect created by baffle 116 effectively makes up the velocity and pressure deficit of the first portion of liquid flowing through first tube 110 and pulls that first portion of liquid into intersection 114 such that it has an equivalent or nearly equivalent velocity and pressure as the second portion of liquid when the portions of liquid reach intersection 114.

Further, in addition to balancing the flow of the first portion of liquid and the flow of the second portion of liquid by pulling the portion of liquid with the lower velocity and/or pressure, the venturi effect created by baffle 116 helps to pull and prime first pump 28 and/or second pump 30. That is, as one example, where first pump 28 (or second pump 30) is not operating, or the impeller in first pump 28 (or second pump 30) is rotating at lower RPMs than the impeller in second pump 30 (or first pump 28), the venturi effect created by baffle 116 will help prime and start first pump 28 (or second pump 30), or pull the RPMs of the impeller in first pump 28 (or second pump 30) up to be closer to, or the same as, the RPMs of the impeller in second pump 30 (or first pump 28).

As described above, in the arrangement shown as one example, baffle 116 not only smooths the convergence of the flow of liquid at intersection 114 and prevents the first portion of liquid from traveling down second tube 112 and prevents the second portion of liquid from traveling down first tube 110, but baffle 116 also balances the flow of the first portion of liquid and the flow of the second portion of liquid as they enter into intersection 114. With this effect, baffle 116 increases the efficiency of system 10 and creates a unique and unexpected advantage to system 10.

While baffle 116 has been described according the arrangement shown, as one example, it will be understood by those skilled in the art that any other configuration of baffle 116 may be used in order to smooth the convergence of the flow of liquid at intersection 114, prevent the first portion of liquid from traveling down second tube 112, prevent the second portion of liquid from traveling down first tube 110, and create a venturi effect that balances the flow and/or pressure of the first portion of liquid and the flow and/or pressure of the second portion of liquid as they enter into intersection 114.

Coupling: In the arrangement shown, as one example, liquid outlet system 32 includes coupling 118. Coupling 118 is formed of any suitable size, shape, and design and is configured to facilitate fluid connection between first tube 110, second tube 112, and flow meter 120. In the arrangement shown, as one example, coupling 118 is a generally cylindrical and hollow member extending a length between a first end 138 and a second end 140. In the arrangement shown, as one example, coupling 118 has a 10-inch diameter, however any other size coupling may be used as coupling 118.

In the arrangement shown as one example, coupling 118 may be formed of a single, unitary member that is formed in a manufacturing process such as machining, additive manufacturing, casting, extrusion, or the like to form a unitary and monolithic member. Alternatively, coupling 118 may be formed of multiple pieces that are connected or assembled to one another through welding or a similar process. In the arrangement shown, as one example, coupling 118 is formed primarily of a metallic material such as steel, aluminum, chromium, or any other metallic material, alloy, and/or composite thereof. Alternatively, coupling 118 may be formed of a non-metallic material such as a plastic material, a fiberglass material, or any other non-metallic material and/or composite thereof.

In the arrangement shown, as one example, the first end 138 of coupling 118 connects to first tube 110 and second tube 112 at intersection 114 and allows baffle 116 to extend partially into coupling 118. Again, in the arrangement shown as one example, the diameter of coupling 118 is greater than the diameter of first tube 110 and/or second tube 112 to ensure the pressure within system 10 does not increase to an undesired pressure as the first portion of liquid and the second portion of liquid converge at intersection 114. In the arrangement shown, as one example, the second end 140 of coupling 118 connects to flow meter 120 of liquid outlet system 32.

Flow Meter: In the arrangement shown, as one example, liquid outlet system 32 includes a flow meter 120. Flow meter 120 is formed of any suitable size, shape, and design and is configured to measure the flow rate of liquid after converging at intersection 114. In the arrangement shown, as one example, flow meter 120 is an electromagnetic flow meter, such as by way of example and not limitation, a Khrone® Waterflux® 3300, or a similar electromagnetic flow meter. In the arrangement shown, as one example, with the flow meter 120 being an electromagnetic flow meter, flow meter 120 measures resistance on the first end 142 and second end 144 of flow meter 120 and, from the resistance, flow meter 120 is able to calculate the flow (such as in gallons per minute) of the liquid flowing through flow meter 120. While flow meter 120 has been described as an electromagnetic flow meter configured to measure resistance and calculate flow, any other type of flow meter may be used as flow meter 120 such as, by way of example and not limitation, a Coriolis mass flowmeter, an ultrasonic flowmeter, a differential pressure flowmeter, a vortex flowmeter, or any other type of flow meter.

In the arrangement shown, as one example, the first end 142 of flow meter 120 connects to the second end 140 of coupling 118 and the second end 144 of flow meter 120 connects to outlet tube 122. In the arrangement shown, as one example, the first portion of liquid flows from first tube 110 and the second portion of liquid flows from second tube 112 and converge at intersection 114, where baffle 116 smooths the flow and the combined flow of liquid flows into and through coupling 118. Once the liquid flows through coupling 118, in the arrangement shown as one example, the resistance of the liquid is measured at the first end 142 of flow meter 120, the liquid flows through flow meter 120, and as it exits the second end 144 of flow meter 120 the resistance is measured again. From the resistance measurements, the flow meter 120 is able to measure the flow (in gallons per minute) of the liquid. Once the liquid flows out of flow meter 120 through second end 144 it enters outlet tube 122.

Outlet Tube: In the arrangement shown, as one example, liquid outlet system 32 includes an outlet tube 122. Outlet tube 122 is formed of any suitable size, shape, and design and is configured to connect to a hose or pipe and expel liquid from system 10. In the arrangement shown, as one example, outlet tube 122 is a generally cylindrical and hollow member which extends a length between a first end 146 and a second end 148. In the arrangement shown, as one example, outlet tube 122 is a tube with a 10-inch diameter, however any other size tube may be used as outlet tube 122. In the arrangement shown, as one example, the first end 146 of outlet tube 122 connects to flow meter 120 and the second end 148 of outlet tube 122 connects to a hose outlet 150.

In the arrangement shown, as one example, outlet tube 122 is formed of multiple pieces that are connected or assembled to one another through welding, bolting, screwing, riveting, or a similar process. Alternatively, outlet tube 122 may be formed of a single, unitary member that is formed in a manufacturing process such as machining, additive manufacturing, casting, extrusion, or the like to form a unitary and monolithic member. In the arrangement shown, as one example, outlet tube 122 is formed primarily of a metallic material such as steel, aluminum, chromium, or any other metallic material, alloy, and/or composite thereof. Alternatively, outlet tube 122 may be formed of a non-metallic material such as a plastic material, a fiberglass material, or any other non-metallic material and/or composite thereof.

In the arrangement shown, as one example, the outlets 102 of first pump 28 and second pump 30 are located at the top of first pump 28 and second pump 30, such that the liquid exists first pump 28 and second pump 30 at a position higher than it entered system 10. In the arrangement shown, as one example, the hose outlet 150 of outlet tube 122 is located in the same vertical plane as hose inlet 52, therefore outlet tube 122 includes a first angled portion 152 near its first end 146. First angled portion 152 angles approximately 90-degrees downward, in a rounded manner, before outlet tube 122 extends downward at vertical portion 154. The vertical portion 154 of outlet tube 122 connects to a second angled portion 156 of outlet tube 122. Second angled portion 156 of outlet tube 122 includes another approximately 90-degree, rounded angle which directs outlet tube 122 horizontally, and the second angled portion 156 connects to the horizontal portion 158 of outlet tube 122. In the arrangement shown, as one example, the horizontal portion 158 of outlet tube 122 is generally on the same vertical plane as hose inlet 52 and the horizontal portion 158 of outlet tube 122 connects to hose outlet 150. In the arrangement shown, as one example, the first angled portion 152, vertical portion 154, second angled portion 156, and horizontal portion 158 are each formed of separate 10-inch tubes which are connected together using any manufacturing process, however the embodiment is not so limited and outlet tube 122 may be formed of a single, unitary member that is formed using any manufacturing process.

Hose Outlet: In the arrangement shown, as one example, outlet tube 122 includes hose outlet 150. Hose outlet 150 is formed of any suitable size, shape, and design and is configured to allow liquid to be expelled from system 10. In the arrangement shown, as one example, hose outlet 150 is a hose fitting or similar connection member which allows outlet tube 122 to connect to a hose or pipe and liquid can flow from outlet tube 122 into said hose or pipe to be expelled from system 10. In the arrangement shown, as one example, hose outlet 150 may be a 12-inch diameter hook-up configured to connect to a 12-inch diameter lay-flat hose, however any other size or configuration of hose outlet 150 may be used.

In the arrangement shown, as one example, hose outlet 150 is connected to the horizontal portion 158 of outlet tube 122 and also to first coupling 56 of liquid inlet system 26. In the arrangement shown, as one example, hose outlet 150 is in approximate vertical alignment with hose inlet 52. That is, in the arrangement shown as one example, first coupling 56 extends between hose inlet 52 and hose outlet 150 in a planar fashion such that hose inlet 52 and hose outlet 150 are vertically aligned. This vertical alignment is important when performing cleaning operations or when system 10 serves as a passthrough and/or as a means to simply connect two hoses or pipes. In the arrangement shown, as one example, system 10 may serve as a passthrough and/or as a means to simply connect two hoses or pipes, and in such situations liquid may flow into hose inlet 52, through first coupling 56, and out hose outlet 150, or liquid may flow into hose outlet 150, through first coupling 56, and out hose inlet 52. The connection between hose outlet 150 and first coupling 56 allows for system 10 to be used in this way. In the arrangement shown, as one example, gate 78 is included where first coupling 56 and hose outlet 150 meet. As described above, gate 78 will generally be closed when system 10 is operated so that liquid flowing into liquid inlet system 26 does not inadvertently flow out of hose outlet 150 before desired, and likewise so that liquid being expelled through outlet tube 122 does not inadvertently flow into first coupling 56.

Recirculation Pipe: In the arrangement shown, as one example, liquid outlet system 32 includes a recirculation pipe 124. Recirculation pipe 124 is formed of any suitable size, shape, and design and is configured to facilitate cleaning of system 10. In the arrangement shown, as one example, recirculation pipe 124 is a hollow, cylindrical pipe which extends a length between opposing ends. In the arrangement shown, as one example, recirculation pipe 124 connects at one opposing end to the vertical portion 154 of outlet tube 122 such that it is in fluid connection with outlet tube 122. In this arrangement, as one example, recirculation pipe 124 connects to the vertical portion 154 of outlet tube 122 at an angle, and this angle allows the liquid flowing through outlet tube 122 to continue through outlet tube 122 during normal operation of system 10. Said another way, recirculation pipe 124 is connected to the vertical portion 154 of outlet tube 122 at an angle so that liquid flowing through outlet tube 122 will not enter recirculation pipe 124 unless otherwise directed into recirculation pipe 124. In the arrangement shown, as one example, the other opposing end of recirculation pipe 124 may be connected to a vacuum hose or pump and the vacuum hose or pump can be used to pull liquid or other materials out of system 10 through recirculation pipe 124, thereby facilitating cleaning of system 10.

While liquid outlet system 32 and its various components have been described according to the arrangements shown, as examples, it will be understood by those skilled in the art that any other arrangement or configuration of liquid outlet system 32 and its various components may be used in order to connect to first pump 28 and second pump 30 and expel liquid from system 10.

### Control System

In the arrangement shown, as one example, system 10 includes control system 34. Control system 34 is formed of any suitable size, shape, and design and is configured to control operation of some or all of the components of system 10. In the arrangement shown, as one example, control system 34 includes a master control system 162, a first control system 164, and a second control system 166.

Master Control System: In the arrangement shown, as one example, control system 34 includes a master control system 162. Master control system 162 is formed of any suitable size, shape, and design and is configured to control operation of first control system 164 and second control system 166 and monitor performance of system 10 as a whole. In the arrangement shown, as one example, master control system 162 includes a plurality of pressure sensors 170, as well as one or more microprocessors 172, memory 174 (or one or more memory devices 174) and instructions 176, among multiple other components and systems.

In the arrangement shown, as one example, master control system 162 is electrically connected, either through wired connections or wirelessly, to sensors and other electronic components, including to the plurality of pressure sensors 170 placed throughout system 10 and to the flow meter 120 of liquid outlet system 32, which are configured to provide information to master control system 162. In the arrangement shown, as one example, master control system 162 is also connected to both first control system 164 and second control system 166. In the arrangement shown, as one example, the sensors and other electronic components positioned throughout system 10, including the plurality of pressure sensors 170 and flow meter 120, record and relay information to microprocessor 172, which processes this information and outputs commands according to instructions 176 stored in memory 174. These commands are communicated to first control system 164 and second control system 166 through any communication protocols and/or communication means.

Microprocessor 172 is any computing device that receives and processes information and outputs commands according to instructions 176 stored in memory 174. Memory 174 is any form of information storage such as flash memory, ram memory, a hard drive, or any other form of memory. Memory 174 may be included as part of microprocessor 172, or memory 174 may be otherwise communicatively connected to microprocessor 172. Master control system 162 may be a single component that is located at a single physical location. Alternatively, master control system 162 may be formed of multiple electronic components that are separated but electrically and communicatively connected to one another and act in concert with one another. Microprocessor 172 may be a single component that is located at a single physical location. Alternatively, microprocessor 172 may be formed of multiple electronic components that are separated but electrically and communicatively connected to one another that act in concert with one another. Memory 174 may be a single component that is located at a single physical location. Alternatively, memory 174 may be formed of multiple electronic components that are separated but electrically and communicatively connected to one another that act in concert with one another. Microprocessor 172 and memory 174 may be a single joined component that is located at a single physical location. Alternatively, microprocessor 172 and memory 174 may be formed of multiple electronic components that are separated but electrically and communicatively connected to one another that act in concert with one another.

In one arrangement, master control system 162, with its microprocessor 172, memory 174 and instructions 176 controls operation of system 10 in a continuous manner. That is, master control system 162 senses operational characteristics of the components of the system 10 and adjusts various operational characteristics both in a reactionary manner as well as in a proactive manner so as to optimize operation of the system 10. In one arrangement, artificial intelligence and machine learning is applied to system 10 through master control system 162 to help manage and operate system 10.

In the arrangement shown, as one example, master control system 162 includes the plurality of pressure sensors 170. The plurality of pressure sensors 170 are formed of any suitable size, shape, and design and are configured to measure pressure of the liquid flowing through system 10 at various positions. In the arrangement shown, as one example, at least one of the plurality of pressure sensors 170 is placed in one or both of opening 89 of first conduit 62 and/or opening 94 of second conduit 64. In the arrangement shown, as one example, the pressure sensors 170 in opening 89 of first conduit 62 and/or opening 94 of second conduit 64 measure inlet pressure of the liquid entering system 10. In the arrangement shown, as one example, at least one of the plurality of pressure sensors 170 is placed in opening 127 of first tube 110 and/or opening 131 of second tube 112. In the arrangement shown, as one example, the pressure sensors 170 in opening 127 of first tube 110 and/or opening 131 of second tube 112 measure outlet pressure of liquid leaving first pump 28 and second pump 30, respectively.

In the arrangement shown, as one example, master control system 162 is electrically connected to each of the plurality of pressure sensors 170 and pressure measurements taken by the pressure sensors 170 are sent to microprocessor 172 of master control system 162 and can be monitored to ensure they are within a desired minimum and maximum pressure range. In the arrangement shown, as one example, master control system 162 is in electrical connection with flow meter 120 such that the measurements of resistance taken by flow meter 120, and the rate of flow measured by flow meter 120, are sent to the microprocessor 172 of master control system 162 and can be monitored to ensure they are within a desired minimum and maximum flow rate range.

In the arrangement shown, as one example, master control system 162 may control (i.e. open, close, or partially close) gate 66 of hose inlet 52, one or more valves 68 of reservoir inlets 54, gate 78 of first coupling 56, gate 129 of first tube 110, and/or gate 133 of second tube 112. In the arrangement shown, as one example, master control system 162 may control any of gate 66, one or more valves 68, gate 78, gate 129, and/or gate 133 individually and master control system 162 may control any combination of, or all of gate 66, one or more valves 68, gate 78, gate 129, and/or gate 133 simultaneously. In this way, in the arrangement shown as one example, master control system 162 can control the flow of liquid through system 10 such that the liquid flows along a desired path or flows through various components of system 10 at a desired pressure. In the arrangement shown, as one example, master control system 162 may control gate 66, one or more valves 68, gate 78, gate 129, and/or gate 133 according to instructions 176 on memory 174, or a user may send commands to master control system 162 in order to control gate 66, one or more valves 68, gate 78, gate 129, and/or gate 133.

In the arrangement shown, as one example, master control system 162 controls first control system 164 and second control system 166. In the arrangement shown, as one example, master control system 162 receives information from the plurality of pressure sensors 170 and flow meter 120 and determines whether the measurements taken are within the desired minimum and maximum pressure and flow rate ranges, respectively. Depending on the measurements taken, master control system 162 may determine that a higher or lower pressure, or a higher or lower flow rate, is desired and master control system 162 will send instructions to first control system 164 and/or second control system 166 to make proper adjustments to first pump 28 and/or second pump 30, respectively.

First Control System: In the arrangement shown, as one example, control system 34 includes a first control system 164. First control system 164 is formed of any suitable size, shape, and design and is configured to control the operation of, and monitor the performance of, first pump 28 and first engine 104. In the arrangement shown, as one example, first control system 164 includes one or more microprocessors 180, memory 182 (or one or more memory devices 182) and instructions 184, among multiple other components and systems.

In the arrangement shown, as one example, first control system 164 is electrically and communicatively connected, either through wired connections or wirelessly, to electronic components of first pump 28 and first engine 104. In the arrangement shown, as one example, first control system 164 receives information regarding the performance of first pump 28 and first engine 104, then microprocessor 180 processes this information and outputs commands to first pump 28 and/or first engine 104 according to instructions 184 stored in memory 182. In the arrangement shown, as one example, the commands output to first pump 28 and/or first engine 104 may be to increase the RPMs of the impeller within first pump 28, thereby increasing the velocity and pressure of the fluid flowing out of first pump 28.

Microprocessor 180 is any computing device that receives and processes information and outputs commands according to instructions 184 stored in memory 182. Memory 182 is any form of information storage such as flash memory, ram memory, a hard drive, or any other form of memory. Memory 182 may be included as part of microprocessor 172, or memory 174 may be otherwise communicatively connected to microprocessor 180. First control system 164 may be a single component that is located at a single physical location. Alternatively, first control system 164 may be formed of multiple electronic components that are separated but electrically and communicatively connected to one another and act in concert with one another. Microprocessor 180 may be a single component that is located at a single physical location. Alternatively, microprocessor 180 may be formed of multiple electronic components that are separated but electrically and communicatively connected to one another that act in concert with one another. Memory 182 may be a single component that is located at a single physical location. Alternatively, memory 182 may be formed of multiple electronic components that are separated but electrically and communicatively connected to one another that act in concert with one another. Microprocessor 180 and memory 182 may be a single joined component that is located at a single physical location. Alternatively, microprocessor 180 and memory 182 may be formed of multiple electronic components that are separated but electrically and communicatively connected to one another that act in concert with one another.

In one arrangement, first control system 164, with its microprocessor 180, memory 182 and instructions 184 controls operation of first pump 28 and first engine 104 in a continuous manner. That is, first control system 164 senses operational characteristics of the components of first pump 28 and first engine 104 and adjusts various operational characteristics both in a reactionary manner as well as in a proactive manner so as to optimize operation of system 10. In one arrangement, artificial intelligence and machine learning is applied to system 10 through first control system 164 to help manage and operate system 10.

Second Control System: In the arrangement shown, as one example, control system 34 includes a second control system 166. Second control system 166 is formed of any suitable size, shape, and design and is configured to control the operation of, and monitor the performance of, second pump 30 and second engine 106. In the arrangement shown, as one example, second control system 166 includes one or more microprocessors 190, memory 192 (or one or more memory devices 192) and instructions 194, among multiple other components and systems.

In the arrangement shown, as one example, second control system 166 is electrically and communicatively connected, either through wired connections or wirelessly, to electronic components of second pump 30 and second engine 106. In the arrangement shown, as one example, second control system 166 receives information regarding the performance of second pump 30 and second engine 106, then microprocessor 190 processes this information and outputs commands to second pump 30 and/or second engine 106 according to instructions 194 stored in memory 192. In the arrangement shown, as one example, the commands output to second pump 30 and/or second engine 106 may be to increase the RPMs of the impeller within second pump 30, thereby increasing the velocity and pressure of the fluid flowing out of second pump 30.

Microprocessor 190 is any computing device that receives and processes information and outputs commands according to instructions 194 stored in memory 192. Memory 192 is any form of information storage such as flash memory, ram memory, a hard drive, or any other form of memory. Memory 192 may be included as part of microprocessor 190, or memory 192 may be otherwise communicatively connected to microprocessor 190. Second control system 166 may be a single component that is located at a single physical location. Alternatively, second control system 166 may be formed of multiple electronic components that are separated but electrically and communicatively connected to one another and act in concert with one another. Microprocessor 190 may be a single component that is located at a single physical location. Alternatively, microprocessor 190 may be formed of multiple electronic components that are separated but electrically and communicatively connected to one another that act in concert with one another. Memory 192 may be a single component that is located at a single physical location. Alternatively, memory 192 may be formed of multiple electronic components that are separated but electrically and communicatively connected to one another that act in concert with one another. Microprocessor 190 and memory 192 may be a single joined component that is located at a single physical location. Alternatively, microprocessor 190 and memory 192 may be formed of multiple electronic components that are separated but electrically and communicatively connected to one another that act in concert with one another.

In one arrangement, second control system 166, with its microprocessor 190, memory 192 and instructions 194 controls operation of second pump 30 and second engine 106 in a continuous manner. That is, second control system 166 senses operational characteristics of the components of second pump 30 and second engine 106 and adjusts various operational characteristics both in a reactionary manner as well as in a proactive manner so as to optimize operation of system 10. In one arrangement, artificial intelligence and machine learning is applied to system 10 through second control system 166 to help manage and operate system 10.

While control system 34 and its various components have been described according the arrangements shown, as examples, it will be understood by those skilled in the art that any other configuration of control system 34 and its various components may be used in order to control operation of some or all of the components of system 10.

### In Operation

System 10 may be operated as a node in a larger liquid pumping system, or it may be operated independently. System 10 may be operated with a hose or pipe pumping water into system 10 through hose inlet 52, or system 10 may be moved near a reservoir of liquid and hoses or pipes may be connected at one end to reservoir inlets 54, with the other end of the hoses or pipes placed in the reservoir, and system 10 may pump the liquid in through reservoir inlets 54. Where pipes are connected to reservoir inlets 54, it may be necessary to tilt the frame 40 of trailer 24 such that the pipes are angled downward and into the reservoir of liquid therefore, in one or more arrangement as one example, trailer 24 may be a tilt trailer configured to tilt the portion of trailer 24 near the rearward end 14 of system 10 downward.

In operation, if only hose inlet 52 is in use, the valves 68 of each of the reservoir inlets 54 are closed such that liquid cannot flow out of liquid inlet system 26 through reservoir inlets 54. In operation, if only reservoir inlets 54 are in use, the gate 66 of hose inlets 52 is closed such that liquid cannot flow out of liquid inlet system 26 through hose inlet 52. In certain situations, as examples, it is desirable to have liquid enter system 10 through each of the reservoir inlets 54 as well as the hose inlet 52. In such situations, hoses or pipes are connected to each of the reservoir inlets 54 as well as to hose inlet 52 and each of the valves 68 as well as gate 66 remain open such that liquid can flow through each of the reservoir inlets 54 as well as the hose inlet 52.

Regardless of whether liquid is entering through hose inlet 52 or reservoir inlets 54, when liquid enters liquid inlet system 26 it will flow through first coupling 56 and then second coupling 58 until it reaches intersection 60. At intersection 60, the liquid will split into a first portion of liquid—which enters into and travels through first conduit 62—and a second portion of liquid—which enters into and travels through second conduit 64. In the arrangement shown, as one example, the first portion of liquid and the second portion of liquid travel in parallel through system 10 between intersection 60 and intersection 114. That is, the first portion of liquid and the second portion of liquid flow through system 10 generally simultaneously, and at a similar pressure and flow rate. As the first portion of liquid flows through the remainder of system 10, it will follow a path through first conduit 62, first pump 28, first tube 110, and finally to intersection 114. As the second portion of liquid flows through the reminder of system 10, it will follow a path through second conduit 64, second pump 30, second tube 112, and finally to intersection 114.

As the first portion of liquid flows through first conduit 62, it will pass one of the plurality of pressure sensors 170, which will measure the pressure of the first portion of liquid. Likewise, as the second portion of liquid flows through second conduit 64, it will pass one of the plurality of pressure sensors 170, which will measure the pressure of the second portion of liquid. The pressure measurements gathered by these plurality of pressure sensors 170 is the inlet pressure of the liquid, and these measurements will be sent to master control system 162 of control system 34 for monitoring and confirmation that they are within the desired minimum and maximum inlet pressure range.

As the first portion of liquid reaches first pump 28, first engine 104 will be providing power to first pump 28 in order for the impeller within first pump 28 to spin at a desired RPMs, either according to commends sent according to instructions 184 of first control system 164 to first pump 28 and/or first engine 104 by first control system 164, or according to commands sent through first control system 164 by a user to first pump 28 and/or first engine 104. When the first portion of liquid reaches first pump 28, it enters first pump 28 through inlet 98 and the impeller forces the first portion of liquid out towards the walls of housing 96 of first pump 28, thereby increasing the pressure and velocity of the first portion of liquid. As the first portion of liquid is forced outward, the first portion of liquid leaves first pump 28 through outlet 102, where it enters first tube 110 and flows to intersection 114.

Similarly (and generally simultaneously as the first portion of liquid), as the second portion of liquid reaches second pump 30, second engine 106 will be providing power to second pump 30 in order for the impeller within second pump 30 to spin at a desired RPMs, either according to commends sent according to instructions 194 of second control system 166 to second pump 30 and/or second engine 106 by second control system 166, or according to commands sent through second control system 166 by a user to second pump 30 and/or second engine 106. When the second portion of liquid reaches second pump 30, it enters second pump 30 through inlet 98 and the impeller forces the second portion of liquid out towards the walls of housing 96 of second pump 30, thereby increasing the pressure and velocity of the second portion of liquid. As the second portion of liquid is forced outward, the second portion of liquid leaves second pump 30 through outlet 102, where it enters second tube 112 and flows to intersection 114.

As the first portion of liquid flows through first tube 110, it passes one of the plurality of pressure sensors 170, which will measure the pressure of the first portion of liquid as it travels through first tube 110. Likewise, as the second portion of liquid flows through second tube 112, it will pass one of the plurality of pressure sensors 170, which will measure the pressure of the second portion of liquid as it passes through second tube 112. The pressure measurements gathered by these plurality of pressure sensors 170 is the outlet pressure of the liquid, and these measurements will be sent to master control system 162 of control system 34 for monitoring and confirmation that they are within the desired minimum and maximum outlet pressure range.

At intersection 114, first tube 110 and second tube 112 converge and the first portion of liquid and the second portion of liquid also converge. In order to smooth the flow of the first portion of liquid and the second portion of liquid as they converge, baffle 116 is present at intersection 114. Not only does baffle 116 smooth the convergence of the flows of liquid at intersection 114, baffle 116 also prevents any of the first portion of liquid from flowing down second tube 112 and any of the second portion of liquid from flowing down first tube 110. Additionally, baffle 116 creates a venturi effect at intersection 114 that balances the flow of the first portion of liquid and the flow of the second portion of liquid, such that the pressure and/or velocity of the first portion of liquid and the second portion of liquid are generally balanced.

After the first portion of liquid and the second portion of liquid converge at intersection 114, the combined liquid flows through coupling 118 and into flow meter 120. As the liquid enters flow meter 120 at the first end 142 of flow meter 120, flow meter 120 measure the resistance of the liquid. Additionally, as the liquid leaves flow meter 120 through the second end 144 of flow meter 120, flow meter 120 measures the resistance of the liquid again. From these measurements, flow meter 120 can measure the flow rate (in gallons per minute) of liquid running through system 10. Flow meter 120 will send these measurements to master control system 162 for monitoring and confirmation that the liquid is flowing at the desired flow rate. In the arrangement shown, as one example, the desired flow rate may be 4,200 gallons per minute, specifically when used in connection with oil and gas extraction operations, or the desired flow rate may be any other flow rate.

In the arrangement shown, as one example, if the flow rate measured by flow meter 120, or any of the pressures measured by any of the plurality of pressure sensors 170 is not within the desired range, master control system 162 can send commands to first control system 164 and/or second control system 166 in order to increase or decrease the RPMs at which the impellers within first pump 28 and/or second pump 30, respectively, are rotating. By varying the RPMs of the impellers within first pump 28 and/or second pump 30, this will change the pressure and velocity at which liquid is flowing through system 10. In other words, through varying the RPMs of the impellers within first pump 28 and/or second pump 30, the pressure and flow rate of the liquid through system 10 can be brought within the desired minimum and maximum pressure and flow rate ranges.

Once the liquid flows out of flow meter 120, the liquid travels through outlet tube 122 and is expelled from system 10 through hose outlet 150. Hose outlet 150 may be connected to a hose with a nozzle configured to spray the liquid at a desired spot, or hose outlet 150 may be connected to a pipe which connects to other various components or systems, as desired.

### Cleanout Operation

At times it may be desirable to clean out the hoses or pipes connected to system 10, as well as system 10 itself. As one example, to clean the hoses or pipes connected to system 10 the hoses or pipes may be be “pigged” out using either bypass pigging or non-bypass pigging. In this operation, a pig is sent through the hoses or pipes which forces unwanted material out of the hoses or pipes. When performing a pigging process while the hoses or pipes are connected to hose inlet 52 and hose outlet 150 of system 10, the pig must be able to pass through at least a portion of system 10. In order to accomplish this, gate 66 of hose inlet 52 is moved to the open position (if not already there) and gate 78 of first coupling 56 is also moved to the open position (if not already there). The pig is then launched through the hoses or pipes and, when the pig reaches system 10, it will pass through gate 66, into and through first coupling 56, then through gate 78 and out hose outlet 150. In this way, the hoses or pipes connected to hose inlet 52 and/or hose outlet 150 may be pigged out while still connected to system 10.

Either separate from a pigging process, or after a pigging process has been performed, it may be desired to clean system 10 out as well. In one arrangement, to clean material out of system 10, gate 66 of hose inlet 52 will be moved to the closed position (if not already there) and gate 78 of first coupling 56 will be moved to the closed position (if not already there). A vacuum hose or pump will then be connected to recirculation pipe 124 and turned on in order to suck material out of system 10. With gate 66 and gate 78 closed, material will be forced to travel from first coupling 56, second coupling 58, first conduit 62, second conduit 64, first pump 28, second pump 30, first tube 110, second tube 112, coupling 118, flow meter 120, and/or outlet tube 122 into and through recirculation pipe 124. Once the material has moved into and through recirculation pipe 124, system 10 is clean and the vacuum hose or pump may be disconnected from recirculation pipe 124.

From the above discussion it will be appreciated that system 10 presented herein improves upon the state of the art. Specifically, in one or more arrangements, a pumping system is presented which: meets pumping requirements; utilizes engines and pumps already available and/or owned; improves upon the state of the art; is safe to operate; is easy to transport; is quick to transport; is able to comply with road width travel restrictions; is relatively easy to build; is relatively friendly to build; can be built relatively quickly and efficiently: is easy to operate; is relatively cost friendly to manufacture; is aesthetically appealing; is robust; is water resistant; is relatively inexpensive: is not easily susceptible to wear and tear; has a long useful life: is efficient to use and operate.

What is claimed:

1. A pumping system comprising:
a plurality of pumps;
the plurality of pumps having inlets;
the plurality of pumps having outlets;
wherein liquid is configured to enter the plurality of pumps through the inlets and exit the plurality of pumps through the outlets;
a plurality of engines;
wherein the plurality of engines are configured to provide power to the plurality of pumps;
a plurality of tubes;
wherein the plurality of tubes are operably connected to the outlets such that liquid exiting the plurality of pumps flows through the plurality of tubes in a parallel manner;
wherein the plurality of tubes converge at an intersection;
wherein the liquid flowing through the plurality of tubes converge at the intersection;
a baffle;
wherein the baffle is positioned at the intersection; and
wherein the baffle is configured to smooth the convergence of the liquid flowing through the plurality of tubes.

2. The pumping system of claim 1, further comprising:
a trailer;
wherein the plurality of pumps are operably connected to the trailer;
wherein the plurality of engines are operably connected to the trailer;
wherein the plurality of tubes are operably connected to the trailer;
wherein the trailer is configured to support the plurality of pumps, the plurality of engines, and the plurality of tubes;
wherein the trailer is transportable.

3. The pumping system of claim 1, further comprising:
the plurality of tubes includes a first tube and a second tube;
wherein the baffle is configured to prevent liquid flowing through the first tube from disturbing liquid flowing through the second tube when the liquid flowing through the plurality of tubes converge at the intersection; and
wherein the baffle is configured to prevent liquid flowing through the second tube from disturbing liquid flowing through the first tube when the liquid flowing through the plurality of tubes converge at the intersection.

4. The pumping system of claim 1, further comprising:
the plurality of tubes includes a first tube and a second tube;
wherein the baffle is configured to prevent liquid flowing through the first tube from entering the second tube;
wherein the baffle is configured to prevent liquid flowing through the second tube from entering the first tube.

5. The pumping system of claim 1, wherein the baffle helps to create a venturi effect in the event that flow rates of liquid flowing through the plurality of tubes vary.

6. The pumping system of claim 1, wherein the liquid enters the plurality of pumps at an inlet pressure, wherein liquid is expelled from the plurality of pumps at an outlet pressure, and wherein the outlet pressure is greater than the inlet pressure.

7. The pumping system of claim 1, further comprising:
a control system;
wherein the control system is configured to monitor and control the pressure and the flow rate of liquid moving through the pumping system.

8. A pumping system comprising:
a plurality of pumps;
the plurality of pumps having inlets;
the plurality of pumps having outlets;
wherein liquid is configured to enter the plurality of pumps through the inlets of the plurality of pumps and exit the plurality of pumps through the outlets of the plurality of pumps;
a plurality of engines;
wherein the plurality of engines are configured to provide power to the plurality of pumps;
a plurality of tubes;
wherein the plurality of tubes are operably connected to the outlets of the plurality of pumps such that liquid exiting the plurality of pumps flows through the plurality of tubes in a parallel manner;
wherein the plurality of tubes converge at an intersection;
wherein the liquid flowing through the plurality of tubes converge at the intersection;
a baffle;
wherein the baffle is positioned at the intersection; and
wherein the baffle helps to create a venturi effect in the event that flow rates of liquid flowing through the plurality of tubes vary.

9. The pumping system of claim 8, further comprising:
a trailer;
wherein the plurality of pumps are operably connected to the trailer;
wherein the plurality of engines are operably connected to the trailer;
wherein the plurality of tubes are operably connected to the trailer;
wherein the trailer is configured to support the plurality of pumps, the plurality of engines, and the plurality of tubes;
wherein the trailer is transportable.

10. The pumping system of claim 8, further comprising:
the plurality of tubes includes a first tube and a second tube;
wherein the baffle is configured to prevent liquid flowing through the first tube from disturbing liquid flowing through the second tube when the liquid flowing through the plurality of tubes converge at the intersection; and
wherein the baffle is configured to prevent liquid flowing through the second tube from disturbing liquid flowing through the first tube when the liquid flowing through the plurality of tubes converge at the intersection.

11. The pumping system of claim 8, further comprising:
the plurality of tubes includes a first tube and a second tube;
wherein the baffle is configured to prevent liquid flowing through the first tube from entering the second tube;
wherein the baffle is configured to prevent liquid flowing through the second tube from entering the first tube.

12. The pumping system of claim 8, wherein the liquid enters the plurality of pumps at an inlet pressure, wherein liquid is expelled from the plurality of pumps at an outlet pressure, and wherein the outlet pressure is greater than the inlet pressure.

13. The pumping system of claim 8, further comprising:
a control system;
wherein the control system is configured to monitor and control the pressure and the flow rate of liquid moving through the pumping system.

14. A pumping system comprising:
a first pump;
the first pump having an inlet;
the first pump having an outlet;
wherein liquid is configured to enter the first pump through the inlet of the first pump and exit the first pump through the outlet of the first pump;
a first engine;
wherein the first engine is configured to provide power to the first pump;
a first tube;
wherein the first tube is operably connected to the outlet of the first pump such that liquid exiting the first pump flows through the first tube;
a second pump;
the second pump having an inlet;
the second pump having an outlet;
wherein liquid is configured to enter the second pump through the inlet of the second pump and exit the second pump through the outlet of the second pump;
a second engine;
wherein the second engine is configured to provide power to the second pump;
a second tube;
wherein the second tube is operably connected to the outlet of the second pump such that liquid exiting the second pump flows through the second tube;
wherein the first tube and the second tube converge at an intersection;
wherein the liquid flowing through the first tube and the liquid flowing through the second tube converge at the intersection;
a baffle;
wherein the baffle is positioned at the intersection;
wherein the baffle is configured to prevent the liquid flowing through the first tube from entering the second tube; and
wherein the baffle is configured to prevent the liquid flowing through the second tube from entering the first tube.

15. The pumping system of claim 14, further comprising:
a trailer;
wherein the first pump and the second pump are operably connected to the trailer;
wherein the first engine and the second engine are operably connected to the trailer;
wherein the first tube and the second tube are operably connected to the trailer;
wherein the trailer is configured to support the first pump, the second pump, the first engine, the second engine, the first tube, and the second tube;
wherein the trailer is transportable.

16. The pumping system of claim 14, further comprising:
wherein the baffle is configured to prevent liquid flowing through the first tube from disturbing liquid flowing through the second tube when the liquid flowing through the first tube and the second tube converge at the intersection; and
wherein the baffle is configured to prevent liquid flowing through the second tube from disturbing liquid flowing through the first tube when the liquid flowing through the first tube and the second tube converge at the intersection.

17. The pumping system of claim 14, wherein the baffle helps to create a venturi effect in the event that flow rates of liquid flowing through the first tube and the second tube vary.

18. The pumping system of claim 14, wherein the liquid enters the first pump and the second pump at an inlet pressure, wherein liquid is expelled from the first pump and the second pump at an outlet pressure, and wherein the outlet pressure is greater than the inlet pressure.

19. The pumping system of claim 14, further comprising:
a control system;
wherein the control system is configured to monitor and control the pressure and the flow rate of liquid moving through the pumping system.
